(19) United States
(12) Patent Application Publication
(10) Pub. No.: US 2004/0023806 A1
(43) Pub. Date: Feb. 5, 2004

(54) N-phenylcarbamates having a microbicide insecticide and acaricide effect

(76) Inventors: Hugo Ziegler, Witterswil (CH); Saleem Farooq, Arisdorf (CH); Rene Zurflüh, B?uuml;lach (CH)

Correspondence Address: BAYER CORPORATION, 100 BAYER ROAD, PITTSBURGH, PA, 15205, US

(21) Appl. No.: 10/148,748

(22) PCT Filed: Dec. 4, 2000
(86) PCT No.: PCT/EP00/12178

(30) Foreign Application Priority Data
Dec. 6, 1999 (CH) 2248/99

(51) Int. Cl. A01N 43/54; A01N 43/40; A01N 43/78; A01N 43/76; A01N 43/80; A01N 43/50; A01N 43/56

(52) U.S. Cl. 504/244; 504/283; 504/310; 504/315; 546/335; 548/566; 558/414; 560/34; 560/35; 504/239; 504/270; 504/266; 504/271; 504/280; 504/275; 504/289

(57) ABSTRACT

The invention relates to novel compounds of the formula I

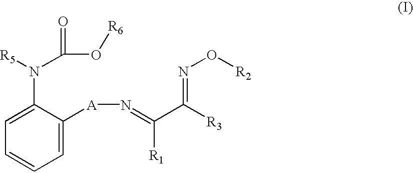

in which

A is —CH₂O— or —CH═N—;

R₁ is C₁-C₄-alkyl or cyclopropyl;

R₂ is C₁-C₆-alkyl, C₂-C₆-alkenyl or C₂-C₆-alkynyl or is C₁-C₆-alkyl substituted by from 1 to 5 fluorine atoms;

R₃ denotes the radicals defined in the description;

R₅ is hydrogen, C₁-C₄-alkyl, C₁-C₂-alkoxymethyl, C₁-C₂-alkylthiomethyl, C₁-C₃-haloalkylmethyl, C₂-C₄-alkenyl, C₂-C₄-alkynyl, C₁-C₃-alkylcarbonyl or C₁-C₂-alkoxycarbonyl, and

R₆ is C₁-C₄-alkyl, which are suitable in agriculture for controlling acarids and insects and for preventing the infestation of crop plants by phytopathogenic fungi.

The present invention relates to novel N-phenylcarbamates having microbicidal, insecticidal and acaricidal activity, to processes for preparing them, to novel intermediates for preparing them, to agrochemical compositions which comprise these active substances, and to their use in agriculture and in the hygiene field for controlling acarids and insects and for preventing the infestation of crop plants by phytopathogenic fungi.

The novel N-phenylcarbamates come under the formula (I)

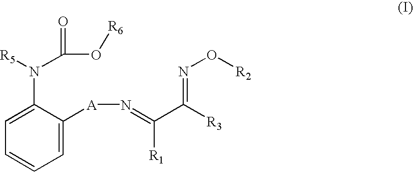

in which

A is —CH₂O— or —CH═N—;

R₁ is C₁-C₄-alkyl or cyclopropyl;

R₂ is C₁-C₆-alkyl, C₂-C₆-alkenyl, or C₂-C₆-alkynyl or is C₁-C₆-alkyl substituted by from 1 to 5 fluorine atoms;

R₃ is C₁-C₆-alkyl, C₁-C₆-alkoxy, C₃-C₆-cycloalkyl, C₃-C₆-cycloalkoxy, C₂-C₆-alkenyl, C₂-C₆-alkenyloxy, C₂-C₆-alkynyl, C₂-C₆-alkynyloxy, C₁-C₆-alkoxycarbonyl or CN, it being possible for the abovementioned: groups except for CN to be substituted by one or more identical or different substituents selected from the group consisting of halogen, cyano, nitro, C₁-C₆-alkoxycarbonyl, C₁-C₆-alkoxy, C₁-C₆-alkylthio, aminocarbonyl, C₁-C₆-alkylaminocarbonyl, di-C₁-C₆-alkylaminocarbonyl, C₂-C₆-alkenyloxy, C₃-C₆-cycloalkyl, C₃-C₆-cycloalkyloxy, heterocyclyl, heterocyclyloxy, aryl, aryloxy, heteroaryl and heteroaryloxy, it being possible for the cyclic radicals to be substituted in turn by one or more identical or different substituents selected from the group consisting of halogen, cyano, nitro, C₁-C₆-alkyl, C₁-C₆-haloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₂-C₆-alkenyl, optionally substituted benzyl, optionally substituted benzyloxy, optionally substituted aryl, optionally substituted aryloxy, optionally substituted heteroaryl and optionally substituted heteroaryloxy; or

R₃ is aryl, heteroaryl, heterocyclyl, aryloxy, heteroaryloxy or heterocyclyloxy, it being possible for the abovementioned groups to be substituted by one or more identical or different substituents selected from the group consisting of halogen, C₁-C₆-alkyl, C₁-C₆-alkoxy, halo-C₁-C₆-alkoxy, halo-C₁-C₆-alkyl, C₁-C₆-alkylthio, halo-C₁-C₆-alkylthio, C₁-C₆-alkylsulphinyl, halo-C₁-C₆-alkylsulphinyl, C₁-C₆-alkylsulphonyl, halo-C₁-C₆-alkylsulphonyl, C₂-C₆-alkenyl, C₂-C₆-alkenyloxy, C₂-C₆-alkynyl, C₃-C₆-alkynyloxy, C₁-C₆-alkylcarbonyl, halo-C₁-C₆-alkylcarbonyl, C₁-C₆-alkoxycarbonyl, halo-C₁-C₆-alkoxycarbonyl, C₁-C₆-alkylaminocarbonyl, di-(C₁-C₆-alkyl)-aminocarbonyl, the alkyl groups being identical or different, C₁-C₆-alkylaminothiocarbonyl, di-(C₁-C₆-alkyl)-aminothiocarbonyl, the alkyl groups being identical or different, C₁-C₆-alkylamino, di-(C₁-C₆-alkyl)-amino, NO₂, a C₁-C₄-alkylenedioxy group which is unsubstituted or substituted from one to four times by C₁-C₄-alkyl and/or halogen; CN, SF₅, OH and QR₄;

Q is a direct bond, oxygen, —O(C₁-C₆-alkylene)-, —(C₁-C₆-alkylene)O—, S(═O)p, —S(═O)p(C₁-C₆-alkylene)-, (C₁-C₆-alkylene)S(═O)p, C₁-C₈-alkylene, C₂-C₆-alkenylene or C₂-C₆-alkynylene;

R₄ is a C₂-C₆-alkenyl or C₂-C₆-alkynyl group which is unsubstituted or substituted by from 1 to 3 halogen atoms; a (C₁-C₄-alkyl)₃Si group, the alkyl groups being identical or different, CN, an unsubstituted or mono- to pentasubstituted C₃-C₆-cycloalkyl, aryl, heteroaryl or heterocyclyl group, the substituents being selected from the group consisting of halogen, C₁-C₆-alkyl, halo-C₁-C₆₇alkyl, C₁-C₆-alkoxy, halo-C₁-C₆-alkoxy, phenoxy, CN, SF₅, NO₂, C₁-C₆-alkylsulphinyl, halo-C₁-C₆-alkylsulphinyl, C₁-C₆-alkylsulphonyl, halo-C₁-C₆-alkylsulphonyl and a C₁-C₄-alkylenedioxy which is unsubstituted or substituted from one to four times by C₁-C₄-alkyl and/or halogen;

p is 0, 1 or 2;

R₅ is hydrogen, C₁-C₄-alkyl, C₁-C₂-alkoxymethyl, C₁-C₂-alkylthiomethyl, C₁-C₃-haloalkylmethyl, C₂-C₄-alkenyl, C₂-C₄-alkynyl, C₁-C₃-alkylcarbonyl or C₁-C₂-alkoxycarbonyl, and

R₆ is C₁-C₄-alkyl.

The formula I is intended to embrace all possible isomeric forms and also mixtures thereof, e.g. racemic mixtures and E/Z mixtures.

Alkyl as a group per se and also as a structural element of another group, such as of haloalkyl, alkoxy, haloalkoxy, alkylamino, alkylthio, haloalkylthio, alkylsulphinyl, alkylsulphonyl, alkylcarbonyl, alkoxycarbonyl, alkylaminocarbonyl or groups derived therefrom is either straight-chain such as, for example, methyl, ethyl, propyl, butyl, pentyl or hexyl, or branched such as, for example, isopropyl, isobutyl, sec-butyl, tert-butyl, isopentyl, neopentyl or isohexyl.

Alkenyl as a group per se and also as a structural element of another group such as of haloalkenyl is either straight-chain, such as vinyl, allyl, 1-propenyl, 1-butenyl, 2-buten-1-yl, 3-buten-1-yl, 1-pentenyl or 2-hexenyl, or branched, such as 1-methylvinyl, isopropenyl, isobutenyl or isoamyl.

Alkynyl as a group per se and also as a structural element of another group, such as of haloalkynyl, is either straight-chain, such as propargyl, 2-butyn-1-yl, 3-butyn-1-yl or 5-hexyn-1-yl, or branched, such as 2-ethynylpropyl or 2-propargylisopropyl.

Alkylenedioxy is —O(alkylene)O—.

Alkylene as a group per se and also as a structural element of other groups, such as of O(alkylene), (alkylene)O, S(═O)p(alkylene), (alkylene)S(═O)p or alkylenedioxy, is either straight-chain, such as —CH₂CH₂—, —CH₂CH₂CH₂— or —CH₂CH₂CH₂CH₂— or branched, such as —CH(CH₃)—, —CH(C₂H₅)—, —C(CH₃)₂—, —CH(CH₃)CH₂— or —CH(CH₃)CH(CH₃)—.

Alkenylene is either straight-chain, such as vin-1,2-ylene, all-1,3-ylene, but-1-en-1,4-ylene or hex-2-en-1,6-ylene, or branched such as 1-methylvin-1,2-ylene.

Alkynylene is either straight-chain, such as propargylene, 2-butynylene or 5-hexynylene, or branched, such as 2-ethynylpropylene or 2-propargylisopropylene.

Halogen stands for fluorine, chlorine, bromine or iodine, preferably for fluorine, chlorine or bromine.

Haloalkyl, haloalkoxy, haloalkylthio, haloalkylsulphinyl or haloalkylsulphonyl may contain identical or different halogen atoms.

Haloalkylmethyl stands for a haloalkyl, such as 2-chloroethyl, 2-chloropropyl, 2-fluoroethyl, 2-chloro-2-fluoroethyl, 2,2-difluoroethyl, 2,2,2-trifluoroethyl, 2,2,3,3,3-pentafluoropropyl or 3-bromopropyl, which is attached via a methylene group.

Aryl is a cyclic aromatic hydrocarbon group such as phenyl, naphthyl or anthracenyl, but preferably phenyl.

Heteroaryl is a cyclic aromatic group having from 5 to 9 ring members in one or two rings, of which from 1 to 3 members are heteroatoms selected from the group consisting of oxygen, nitrogen and sulphur. One or two benzo rings may be fused onto the heterocycle, attachment to the remainder of the molecule being via either the heterocycle moiety or the benzo moiety. Examples are benzimidazolyl, benzisoxazolyl, benzisothiazolyl, benzocoumarinyl, benzofryl, benzothiadiazolyl, benzothiazolyl, benzothienyl, benzoxazolyl, benzoxadiazolyl, quinazolinyl, quinolyl, quinoxalinyl, carbazolyl, dihydrobenzofuryl, furyl, imidazolyl, indazolyl, indolyl, isoquinolinyl, isothiazolyl, isoxazolyl, methylenedioxyphenyl, ethylenedioxyphenyl, naphthyridinyl, oxazolyl, phenanthridinyl, phthalazinyl, pteridinyl, purinyl, pyrazinyl, pyrazolyl, pyridazinyl, pyrazolo[3,4-b]pyridyl, pyridyl, pyrimidinyl, pyrrolyl, tetrazolyl, oxadiazolyl, thiadiazolyl, thiazolyl, thienyl, triazinyl and triazolyl.

Preference is given to pyridyl, pyrazinyl, pyrimidinyl, thiazolyl, quinolinyl and thienyl.

Heterocyclyl is a 5- to 7-membered nonaromatic ring having from 1 to 3 heteroatoms selected from the group consisting of N, O and S. Preference is given to nonaromatic 5-membered and 6-membered rings containing a nitrogen heteroatom and optionally a further heteroatom. Preferred examples are pyrazolinyl, thiazolinyl and oxazolinyl.

Among the compounds of the formula I, preference is given to those groups in which

a) R₁ is methyl, ethyl or cyclopropyl; or

b) R₁ is methyl; or

c) R₂ is methyl, ethyl, fluoroethyl or trifluoroethyl; or

d) R₂ is methyl; or

e) R₃ is C₁-C₆-alkyl, C₁-C₆-alkoxy, C₂-C₆-alkenyl, C₂-C₆-alkenyloxy, C₂-C₆-alkynyl, C₃-C₆-alkynyloxy, C₃-C₆-cycloalkyl, C₃-C₆-cycloalkyloxy or C₁-C₆-alkoxycarbonyl, it being possible for the aforementioned groups to be partially or fully halogenated; and also CN, OCN or halogen; or

f) R₃ is phenyl which is unsubstituted or substituted from 1 to 3 times by identical or different substituents selected from halogen, C₁-C₆-alkyl, C₁-C₆-haloalkyl, C₁-C₆-alkoxy, C₁-C₆-haloalkoxy, C₂-C₆-alkenyl, C₂-C₆-alkenyloxy, C₂-C₆-alkynyl, C₃-C₆-alkynyloxy, C₁-C₆-alkoxycarbonyl CN, OCN, optionally substituted benzyl, optionally substituted phenyl, or optionally substituted phenoxy, it being possible for the above-mentioned aromatic groups to be substituted by one or more identical or different substituents selected from the group consisting of halogen, cyano, nitro, C₁-C₆-alkyl, C₁-C₆-haloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino and C₂-C₆-alkenyl; or

g) R₃ is QR₄-substituted phenyl, in which Q is a direct bond, oxygen, OCH₂, CH₂O, sulphur, CH₂—CH₂, CH═CH or C≡C and R₄ is phenyl which is unsubstituted or substituted 1, or 2: times by identical or different substituents selected from halogen, C₁-C₄-alkyl, C₁-C₄-haloalkyl, C₁-C₄-alkoxy, C₁-C₄-haloalkoxy, C₂-C₄-alkenyl, C₂-C₄-alkenyloxy, C₂-C₄-alkynyl, C₃-C₄-alkynyloxy, C₁-C₄-alkoxycarbonyl or CN, with QR₄ preferably occupying position 4 of the phenyl ring; or

h) R₃ is pyridyl, pyrimidinyl, furyl, thienyl, oxazolyl, isoxazolyl, thiazolyl, isothiazolyl, imidazolyl or pyrazolyl, each unsubstituted or substituted from 1 to 3 times by identical or different radicals from the group consisting of halogen, cyano, nitro, aminocarbonyl, C₁-C₄-alkyl, C₁-C₄-haloalkyl, C₁-C₄-alkylcarbonyl, C₁-C₄-alkylsulphonyl, C₁-C₆-alkylsulphinyl, C₃-C₆-cycloalkyl, optionally substituted arylcarbonyl, C₁-C₄-alkoxy, C₁-C₄-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl or C₂-C₆-alkenyl; or

i) R₅ is hydrogen, methyl, ethyl, methoxymethyl, allyl, propargyl, 2,2,2-trifluoroethyl, methylcarbonyl, ethylcarbonyl or methoxycarbonyl; or

j) R₆ is methyl or ethyl; or

k) R₆ is preferably methyl; or

l) A is —CH₂O— or —CH═N—.

Further preferred subgroups of the formula I are

(1) compounds of the formula I in which

R₁ is methyl or ethyl, preferably methyl;

R₂ is methyl, ethyl, fluoromethyl or trifluoroethyl, preferably methyl;

R₃ is C₁-C₆-alkyl, C₁-C₆-alkoxy, C₂-C₆-alkenyl, C₂-C₆-alkenyloxy, C₂-C₆-alkynyl, C₃-C₆-alkynyloxy, C₃-C₆-cycloalkyl, C₃-C₆-cycloalkyloxy or C₁-C₆-alkoxycarbonyl, it being possible for the abovementioned groups to be partly or fully halogenated; and also CN, OCN or halogen; or

R₃ is phenyl which is unsubstituted or substituted from 1 to 3 times by identical or different constituents selected from halogen, C₁-C₆-alkyl, C₁-C₆-haloalkyl, C₁-C₆-alkoxy, C₁-C₆-haloalkoxy, C₂-C₆-alkenyl, C₂-C₆-alkenyloxy, C₂-C₆-alkynyl, C₃-C₆-alkynyloxy, C₁-C₆-alkoxycarbonyl, CN, OCN, optionally substituted benzyl, optionally substituted phenyl, or optionally substituted phenoxy, it being possible for the above-mentioned aromatic groups to be substituted by one or more identical or different substituents selected from the group consisting of halogen, cyano, nitro, C₁-C₆-alkyl, C₁-C₆-haloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino and C₂-C₆-alkenyl; or

R₃ is pyridyl, pyrimidinyl, furyl, thienyl, oxazolyl, isoxazolyl, thiazolyl, isothiazolyl, imidazolyl, pyrazolyl, which are unsubstituted or substituted from 1 to 3 times by identical or different substituents selected from halogen, cyano, nitro, aminocarbonyl, C₁-C₄-alkyl, C₁-C₄-haloalkyl, C₁-C₄-alkylcarbonyl, C₁-C₄-alkylsulphonyl, C₁-C₆-alkylsulphoxyl, C₃-C₆-cycloalkyl, optionally substituted arylcarbonyl, C₁-C₄-alkoxy, C₁-C₄-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkyl aminocarbonyl or C₂-C₆-alkenyl;

R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and

A is —CH₂O— or —CH═N—;

(1a) compounds of group (1), in which

R₂ is C₁-C₆-alkyl, fluoromethyl, difluoromethyl or 2,2,2-trifluoroethyl;

R₃ is C₁-C₆-alkyl, C₁-C₆-alkoxy, C₁-C₆-alkoxycarbonyl, CN, C₃-C₆-cycloalkyl, phenyl which is unsubstituted or substituted from 1 to 3 times by halogen, C₁-C₄-alkyl, C₁-C₄-haloalkyl, C₁-C₄-alkoxy, C₁-C₄-haloalkoxy, C₂-C₄-alkenyl, C₂-C₄-alkenyloxy, C₂-C₆-alkynyl, C₃-C₆-alkynyloxy, CN, OCN, benzyl, phenyl, or phenoxy, in which the aromatic groups are unsubstituted or substituted 1 or 2 times by halogen, C₁-C₂-alkyl, C₁-C₂-haloalkyl or C₁-C₂-alkoxy; and

A is-CH₂O—;

(1b) compounds of group (1a) in which

R₃ is C₁-C₄-alkyl, C₁-C₄-alkoxy, or C₁-C₆-alkoxycarbonyl, or is phenyl which is unsubstituted or substituted 1 or 2 times by halogen, C₁-C₂-alkyl, C₁-C₂-haloalkyl or C₁-C₂-alkoxy;

(2) compounds of the formula I in which

R₁ is methyl, ethyl or cyclopropyl, preferably methyl;

R₂ is C₁-C₆-alkyl, preferably methyl or ethyl;

R₃ is C₁-C₆-alkyl, C₁-C₆-haloalkyl, C₂-C₆-alkenyl, C₁-C₆-alkoxy, C₂-C₆-alkenyloxy, C₁-C₆-alkoxycarbonyl, CN, C₃-C₆-cycloalkyl, aryl, heteroaryl, heterocyclyl, aryloxy, heteroaryloxy or heterocyclyloxy, it being possible for the hydrocarbon radicals and the cyclic radicals to be substituted as mentioned previously;

R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and

A is —CH₂O— or —CH═N—;

(2a) compounds of group (2) in which

R₃ is C₁-C₆-alkyl, C₁-C₆-haloalkyl, C₂-C₆-alkenyl, C₁-C₆-alkoxy, C₂-C₆-alkenyloxy, C₁-C₆-alkoxycarbonyl or C₃-C₆-cycloalkyl; and

A is —CH₂O—;

(2b) compounds of group (2a) in which

R₃ is phenyl which is unsubstituted or substituted 1 or 2 times by halogen, C₁-C₄-alkyl, C₁-C₄-haloalkyl, C₁-C₄-alkoxy, C₁-C₄-haloalkoxy, C₂-C₄-alkenyl, C₂-C₄-alkenyloxy, benzyl, phenyl or phenoxy, in which these aromatic groups are unsubstituted or substituted 1 or 2 times by halogen, C₁-C₂-alkyl, C₁-C₂-haloalkyl or C₁-C₂-alkoxy; and

A is —CH₂O— or —CH═N—;

(3) compounds of the formula I in which

R₁ is methyl, ethyl or cyclopropyl;

R₂ is C₁-C₆-alkyl, preferably methyl or ethyl, C₂-C₆-alkenyl, preferably allyl or C₂-C₆-alkynyl, preferably propargyl;

R₃ is phenyl substituted by QR₄;

R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and

A is —CH₂O— or —CH═N—.

Preferred specific compounds of the formula I are:

methyl N-methyl-[2-({2-ethoxyimino-1-methyl-2-[4-(4-trifluoromethylphenoxy)phenyl]ethylidene}hydrazonomethyl)phenyl]carbamate,

methyl N-ethyl-[2-({2-ethoxyimino-1-methyl-2-[4-(4-trifluoromethylphenoxy)phenyl]ethylidene}hydrazonomethyl)phenyl]carbamate,

methyl N-ethyl-[2-({2-ethoxyimino-1-ethyl-2-[4-(4-trifluoromethylphenoxy)phenyl]ethylidene}hydrazonomethyl)phenyl]carbamate,

methyl N-methyl-[2-({2-ethoxyimino-1-ethyl-2-[4-(4-trifluoromethylphenoxy)phenyl]ethylidene}hydrazonomethyl)phenyl]carbamate,

methyl N-methoxymethyl-[2-({2-ethoxyimino-1-methyl-2-[4-(4-trifluoromethylphenoxy)phenyl]ethylidene}hydrazonomethyl)phenyl]carbamate,

methyl N-propargyl-[2-({2-methoxyimino-1-methyl-2-[4-(4-trifluoromethylphenoxy)phenyl]ethylidene}hydrazonomethyl)phenyl]carbamate,

methyl N-propargyl-[2-({2-ethoxyimino-1-methyl-2-[4-(4-trifluoromethylphenoxy)phenyl]ethylidene}hydrazonomethyl)phenyl]carbamate,

methyl N-propargyl-[2-({2-ethoxyimino-1-ethyl-2-[4-(4-trifluoromethylphenoxy)phenyl]ethylidene}hydrazonomethyl)phenyl]carbamate,

methyl N-propargyl-[2-({2-ethoxyimino-1-ethyl-2-[4-(4-trifluoromethylphenoxy)phenyl]ethylidene}hydrazonomethyl)phenyl]carbamate,

methyl N-methyl-[2-({2-methoxyimino-1-methyl-2-(4-chlorophenyl)ethylidene}-hydrazonomethyl)phenyl]carbamate,

methyl N-methyl-[2-({2-methoxyimino-1-methyl-2-(4-fluorophenyl)ethylidene}-hydrazonomethyl)phenyl]carbamate,

methyl N-methoxyethyl-[2-({2-methoxyimino-1-methyl-2-(4-chlorophenyl)ethylidene}hydrazonomethyl)phenyl]carbamate,

methyl N-methoxyethyl-[2-({2-methoxyimino-1-methyl-2-(4-fluorophenyl)ethylidene}hydrazonomethyl)phenyl]carbamate,

methyl N-methyl-[2-({2-methoxyimino-1-methyl-2-[4-(3-trifluoromethylphenoxy)phenyl]ethylidene}hydrazonomethyl)phenyl]carbamate,

methyl N-methyl-[2-(.{2-ethoxyimino-1-ethyl-2-[4-(3-trifluoromethylphenoxy)phenyl]ethylidene}hydrazonomethyl)phenyl]carbamate,

methyl N-methyl-[2-({2-ethoxyimino-1-ethyl-2-[4-(3-trifluoromethylphenoxy)phenyl]ethylidene}hydrazonomethyl)phenyl]carbamate,

methyl N-methyl-[2-({2-methoxyimino-1-methyl-2-[4-(4-chloromethylphenoxy)phenyl]ethylidene}hydrazonomethyl)phenyl]carbamate,

methyl N-methyl-[2-({2-ethoxyimino-1-methyl-2-[4-(4-chloromethylphenoxy)phenyl]ethylidene}hydrazonomethyl)phenyl]carbamate,

methyl N-methyl-{2-[2-(4-fluorophenyl)-2-methoxyimino-1-methyl-ethylideneaminooxymethyl]phenyl}carbamate,

methyl N-ethyl-{2-[2-methyl-2-methoxyimino-1-methyl-ethylideneaminooxymethyl]phenyl}carbamate,

methyl N-ethyl-{2-[2-(4-fluorophenyl)-2-methoxyimino-1-methyl-ethylideneaminooxymethyl]phenyl}carbamate,

methyl N-methoxymethyl-{2-[2-methyl-2-methoxyimino-1-methyl-ethylideneaminooxymethyl]phenyl}carbamate, and

methyl N-methyl-{2-[2-(4-(4-trifluoromethylphenoxy)phenyl)-2-ethoxyimino-1-methylethylideneaminooxymethyl]phenyl}carbamate.

Compounds of the formula I may be prepared as follows:

A) A compound of the formula I in which A is —CH═N— may be prepared by reacting a hydrazone of the general formula II

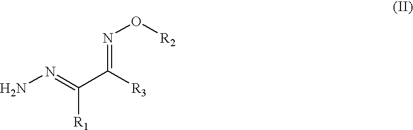

in which R₁, R₂ and R₃ have the meanings indicated under formula I with an aldehyde of the general formula III or one of its acetal or imino derivatives of the general formulae IVa and IVb

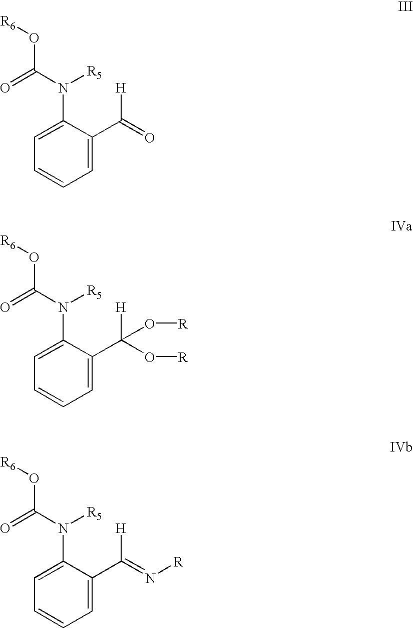

in which R is C₁-C₆-alkyl or the two Rs together with the two oxygen atoms and the carbon to which they are attached are a cyclic acetal.

The compounds of the general formulae II and III are known from the literature (e.g. P. Y. Chong; S. Z. Janicki; P. A. Petillo; J. Org. Chem. (1998), 63(23), 8515-8521, J. M. Muchowski; M. C. Venuti;. J. Org. Chem. (1980), 45(23), 4798-801, S. Witek; J. Bielawski; A. Bielawska; PL-98698, CA 91:91384; Müller, B. et al.; WO 93/15046 (BASF)) or may be prepared by known methods. The compounds of the general formulae IVa and WVb may be obtained in analogy to the methods described under C) and D) or directly from the carbonyl derivatives of the formula III.

B) A compound of the formula I in which A is CH₂O may be prepared by reacting an oxime of the general formula V

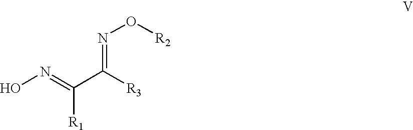

in which R₁, R₂ and R₃ have the meanings indicated under formula I with a benzyl derivative of the general formula VI,

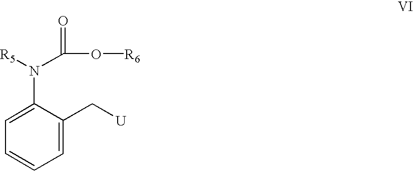

in which R₅ and R₆ have the meanings indicated under formula I and U is a leaving group (e.g. chlorine, bromine, tosyloxy, mesyloxy).

The compounds of the general formulae V and VI are known (e.g. H. Ziegler et al; WO 95/18789 (Novartis), Y. Shiokawa et al; EP-A-268989 (Fujisawa Pharm.)) or may be prepared by known methods.

C) A compound of the formula I in which R₅ is C₁-C₄-alkyl, C₁-C₂-alkoxymethyl, C₁-C₂-alkylthiomethyl, C₁-C₃-haloalkylmethyl, C₂-C₄-alkenyl, C₂-C₄-alkynyl, C₁-C₃-alkylcarbonyl or C₁-C₂-alkoxycarbonyl may be prepared by reacting a compound of the formula Ia

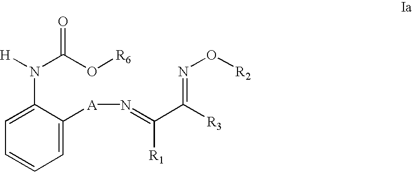

in which A, R₁, R₂, R₃ and R₆ have the meanings indicated under formula I with a compound of the general formula VII,

R₅ₐ-Hal VII

in which R₅ₐ with the exception of hydrogen has the meanings indicated for R₅ and Hal stands for chlorine, bromine or iodine.

D) A compound of the formula I may be prepared by reacting an aniline derivative of the general formula VIII

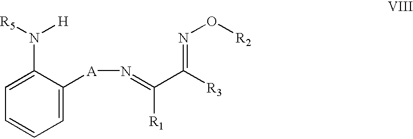

in which R₁, R₂, R₃ and R₅ have the meanings indicated under formula I with a chloroformate of the general formula IX

Cl—COOR₆ IX

The compounds of the formula VIII are novel, and may be prepared by

a) condensing a hydrazone of the formula II with an aldehyde of the formula X or one of its acetal or imino derivatives

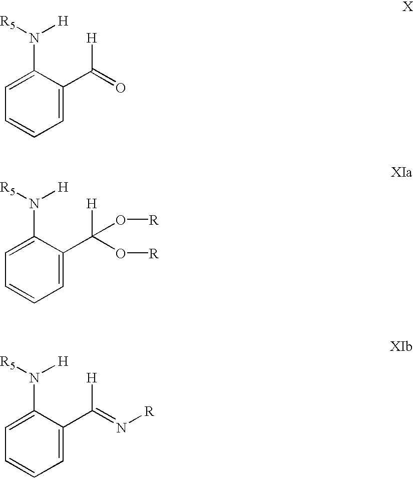

in which R₅ has the meanings indicated under formula I and R has the meanings indicated under formula TV. The compounds of the formulae X, XIa and XIb are known (e.g. T. Sugasawa; H. Hamana; T. Toyota; M. Adachi, JP-55002626 or T. Sugasawa; H. Hamana; T. Toyoda; M. Adachi; Synthesis (1979), (2), 99-100 or W. Heinzelmann; Helv. Chim. Acta (1978), 61(2), 618-25) or may be prepared by known methods, or

b) condensing a ketone of the formula XII

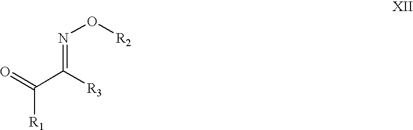

in which R₁-R₃ have the meanings described under formula I with a hydrazone of the formula XIII

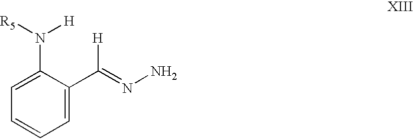

in which R₅ has the meanings indicated under formula I. The compounds of the formula XIII are known (e.g. Adger et al; J. Chem. Soc. Perkin Trans.1; 1975; pp. 31, 33, 36, 37) and may be prepared by condensing the aldehydes X with hydrazine;

c) reacting a benzyl derivative of the general formula XIV

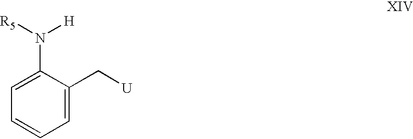

in which R₅ has the meanings indicated under formula I and U is a leaving group (e.g. chlorine, bromine, tosyloxy, mesyloxy) with an oxime of the general formula V.

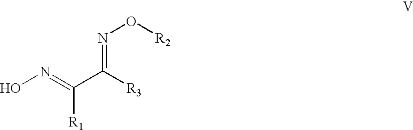

The compounds of the formula XIV are known (cf. e.g. M. Uehara; T. Shimizu; N. Abe; A. Seo; JP-10298156 or J. Liu; R. H. Dodd; J. Heterocycl. Chem. (1995), 32(2), 523-8 or B. Mueller; H. Sauter; F. Roehl; R. Doetzer; G. Lorenz; E. Ammermann; WO 93/15046).

E) A compound of the formula I may be prepared by etherifying an oxime of the general formula XV

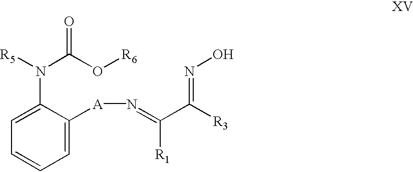

in which R₁, R₃, R₅ and R₆ have the meanings indicated under formula I.

The compounds of the formula XV are novel and may be obtained by

a) reacting a ketone of the general formula XVI

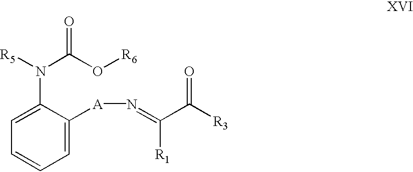

in which R₁, R₃, R₅ and R₆ have the meanings indicated under formula I with hydroxylamine or one of its salts, or

b) reacting a compound of the general formula XVII

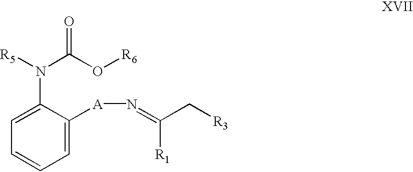

in which R₁, R₃, R₅ and R₆ have the meanings indicated under formula I with nitrous acid or an alkyl nitrite in the presence of an acid or base, or

c) reacting a hydrazone of the general formula XVIII

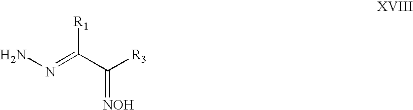

in which R₁ and R₃ have the meanings indicated under formula I with an aldehyde or ketone of the general formula III or an acetal or imine of the general formulae IVa or IVb, respectively, as described under A).

The compounds of the formulae XVI and XVII in which A is —CH═N— are novel and may be obtained in analogy to the preparation of the compounds of the formula I. The compounds of the formulae XVI and XVII in which A is —CH₂—O— are known (e.g. T. Komyoji; I. Shigehara; N. Matsuo; H. Shimoharada; T. Ohshima; T. Akagi; S. Mitani; EP-A-498396 or N. Matsuo; H. Shimoharada; T. Ooshima; S. Mitani; K. Myashita; JP-06056756) or may be obtained by the methods described herein.

The compounds of the formula XVIII are known (e.g. Barany et al., J. Chem. Soc.1951, 1929; Neber; Hartung, Ruopp, Chem. Ber., 58, 1925, 1240; H. Gnichtel;, B. Toepper Liebigs Ann. Chem., GE, 1989, 1071-1074; H. Rapoport; W. Nilsson, J. Amer. Chem. Soc., 83, 1961, 4262-4267).

F) A compound of the formula I may be prepared by reacting a ketone of the general formula XVI with an alkoxyamine of the general formula XIX

R₂—ONH₂ XIX

in which R₂ has the meanings indicated under formula I or with one of its salts.

All of the reactions described above are known per se. The novel, abovementioned intermediates have been developed specifically for the present invention and likewise form a subject of this invention; of particular significance are those of the formulae VIII, XV, XVIa and XVIIa.

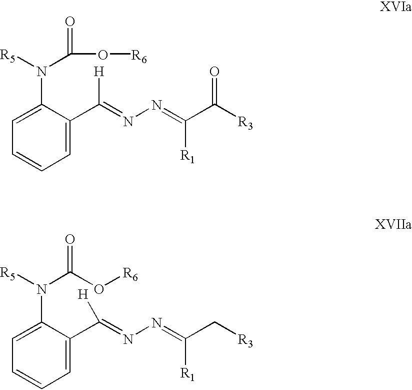

The compounds of the formula I may be employed preventively and/or curatively in the agricultural sector and related fields as active substance in the control of plant pests. The active substances of the formula I according to the invention are distinguished by good activity, even when applied at low concentrations, and by good plant tolerance and environment-friendliness. They possess very advantageous, especially systemic, properties and may be used to protect a large number of crop plants. Using the active substances of the formula I it is possible to contain or destroy the pests which occur on plants or parts of plants (fruits, flowers, foliage,; stalks, tubers, roots) of various crops, with even plant parts which grow at a later point in time remaining unharmed by, for example, phytopathogenic microorganisms.

The compounds I may further be used as dressing agents for treating seed (fruits, tubers, kernels) and plant cuttings for protecting against fungal infections and against soil-borne phytopathogenic fungi.

The compounds I are effective, for example, against the following classes of phytopathogenic fungi: Fungi imperfecti (e.g. Botrytis, Pyricularia, Helminthosporium, Fusarium, Septoria, Cercospora and Alternaria); Basidiomycetes (e.g. Rhizoctonia, Hemileia, Puccinia); Ascomycetes (e.g. Venturia and Erysiphe, Podosphaera, Monilinia, Uncinula) and Oomycetes (e.g. Phytophthora, Pythium, Plasmopara).

Target crops for use in plant protection in the context of the invention are, for example, the following plant species: cereals (wheat, barley, rye, oats, rice, maize, sorghum and related species); beet (sugar beet and fodder beet); pome fruit, stone fruit, and soft fruit (apples, pears, plums, peaches, almonds, cherries, strawberries, raspberries and blackberries); legumes (beans, lentils, peas, soya); oil crops (oilseed rape, mustard, poppies, olives, sunflowers, coconut, castor, cocoa, peanuts); cucurbits (pumpkin, cucumbers, melons); fiber crops (cotton, flax, hemp, jute); citrus fruits (oranges, lemons, grapefruit, tangerines); vegetables (spinach, lettuce, asparagus, cabbages, carrots, onions, tomatoes, potatoes, bell peppers); the laurel family (avocado, Cinnamonium, camphor) and plants such as tobacco, nuts, coffee, aubergines, sugarcane, tea, pepper, grapevines, hops, the plantain family, latex plants, and ornamentals.

Further, the compounds of the formula I according to the invention combine good tolerance by warm-blooded species, fish and plants with valuable activity against insects and pests from the order Acarina, such as occur on crop plants and ornamentals in agriculture, in horticulture and in forestry. The compounds of the formula I are particularly suitable for controlling pests in cotton, vegetable, fruit and rice crops, such as spider mites, aphids, caterpillars of lepidopterans and rice leafhoppers. Primary among the pests which can be controlled are spider mites such as Panonychus ulmi, aphids such as Aphis craccivora, lepidopteran caterpillars such as those of Heliothis virescens, and rice leafhoppers such as Nilaparvata lugens or Nephotettix cincticeps.

The good pesticidal activity of the compounds I according to the invention corresponds to a mortality of at least 50-60% of the pests mentioned.

Further fields of use of the active substances according to the invention are in the protection of stored products and of materials, where the product in storage is protected against rotting and moulding and also against animal pests (e.g. grain weevils, mites, maggots, etc.). In the hygiene sector, compounds of the formula I effect successful control of animal parasites such as ticks, mites, warble flies, etc. on domestic animals and productive livestock. The compounds I are effective against all or individual development stages of both normally sensitive and resistant species of pests. Their activity may be manifested, for example, in killing of the pests, either Immediately or only after a certain time has elapsed, during ecdysis for example, or in reduced oviposition and/or hatching rate.

The compounds I are used in unmodified form or, preferably, together with the auxiliaries customary in the art of formulation. For this purpose they are appropriately processed to, for example, emulsifiable concentrates, spreadable pastes, directly sprayable or dilutable solutions, dilute emulsions, wettable powders, soluble powders, dusts or granules, by means, for example, of encapsulation in, for example, polymeric substances, in a known manner. The application techniques, such as spraying, misting, dusting, broadcasting, brushing on or pouring, like the nature of the compositions, are chosen in accordance with the desired objectives and the prevailing circumstances.

Suitable carriers and additives may be soluble or liquid and are substances which are appropriate in the art of formulation, examples being natural or regenerated minerals, solvents, dispersants, wetting agents, adhesives, thickeners, binders or fertilizers.

The compounds of the formula I may be mixed with further active substances, examples being fertilizers, trace element providers or other crop protection agents, particularly further fungicides. In this context, unexpected synergistic effects may anse.

Preferred co-components are:

azoles, such as azaconazole, bitertanole, bromuconazole, cyproconazole, difenoconazole, diniconazole, epoxiconazole, fenbuconazole, fluquinconazole, flusilazole, flutriafole, hexaconazole, imazalil, imibenconazole, ipconazole, metconazole, myclobutanil, pefurazoate, penconazol, pyrifenox, prochloraz, propiconazole, tebuconazole, tetraconazole, triadimefon, triadimenol, triflumizole, triticonazole;

pyrimidinyl-carbinols, such as ancymidbl, fenarimol, nuarimol;

2-aminopyrimidines, such as bupirimate, dimethirimol, ethirimol;

morpholines, such as dodemorph, fenpropidin, fenpropimorph, spiroxamine, tridemorph;

anilinopyrimidines, such as cyprodinil, mepanipyrim, pyrimethanil;

pyrroles, such as fenpiclonil, fludioxonl;

phenylamides, such as benalaxyl, furalaxyl, metalaxyl, R-metalaxyl, ofurace, oxadixyl;

benzimidazoles, such as benomyl, carbendazim, debacarb, fuberidazole, thiabendazole;

dicarboximides, such as chlozolinate, dichlozoline, iprodione, myclozolin, procymidon, vinclozolin;

carboxamides, such as carboxin, fenfuram, flutolanil, mepronil, oxycarboxin, thifluzamide;

guanidines, such as guazatine, dodine, iminoctadine;

strobilurins, such as azoxystrobin, kresoxim-methyl, metominostrobin, SSF-126, SSF-129, trifloxystrobin;

dithiocarbamates, such as ferbam, mancozeb, maneb, metiram, propineb, thiram, zineb, ziram;

N-halomethylthiophthalimides, such as captafol, captan, dichlofluanid, fluoromide, folpet, tolyfluanid;

Cu compounds, such as Bordeaux mixture, copper hydroxide, copper oxychloride, copper sulphate, cuprous oxide, mancopper, oxine-copper;

nitrophenol derivatives, such as dinocap, nitrothal-isopropyl;

organophosphorus derivatives, such as edifenphos, iprobenphos, isoprothiolane, phosdiphen, pyrazophos, tolclofos-methyl;

miscellaneous, such as AC 382042, acibenzolar S-methyl, anilazine, blasticidin S, chinomethionat, chloroneb, chlorothalonil, cymoxanil, dichlone, diclomezine, dicloran, diethofencarb, dimethomorph, dithianon, etridiazole, famoxadone, fenamidone, fenhexamid, fentin, ferimzone, fluazinam, flusulphamide, fenhexamid, fosetyl-aluminium, hymexazol, IKF-916, iprovalicarb, kasugamycin, methasulphocarb, MON 65500, pencycuron, phthalide, polyoxins, probenazole, propamocarb, pyroquilon, quinoxyfen, quintozene, RH-7281, sulphur, triazoxide, tricyclazole, triforine, validamycin.

One preferred method of applying an active substance of the formula I or an agrochemical composition comprising at least one of these active substances is application to foliage (foliar application). Frequency and rate of application depend on the risk of infestation by the pathogen in question. Alternatively, the active substances I may reach the plant through the soil by the root system (systemic action), by drenching the locus of the plant with a liquid preparation or by incorporating the substances in solid form into the soil, in the form for example of granules (soil application). In the case of paddy rice crops, such granules may be metered into the flooded paddy field. Alternatively, the compounds I may be applied to seed kernels for the purpose of seed treatment (coating), either by soaking the kernels or tubers in a liquid preparation of the active substance or by coating them with a solid preparation.

The compositions are prepared conventionally, for example by intimately mixing and/or grinding the active substance with extenders, such as solvents, solid carriers and, if desired, surface-active compounds (surfactants).

The agrochemical compositions generally contain from 0.1 to 99 percent by weight, in particular from 0.1 to 95 percent by weight, of active substance of the formula I, from 99.9 to 1 percent by weight, in particular from 99.8 to 5 percent by weight, of a solid or liquid additive and from 0 to 25 percent by weight, in particular from 0.1 to 25 percent by weight, of a surfactant.

Favourable application rates are generally from 1 g to 2 kg of active substance (AS) per hectare (ha), preferably from 10 g to 1 kg AS/ha, in particular from 20 g to 600 g AS/ha.

In the case of use as a seed dressing agent, amounts used with advantage are from 10 mg to 1 g of active substance per kg of seed.

While concentrated compositions tend to be preferred as commercial product, the end user generally uses diluted compositions.

The compositions may also comprise further additives, such as stabilizers, defoamers, viscosity regulators, binders or adhesives, and also fertilizers or other active substances for obtaining specific effects.

### PREPARATION EXAMPLES

Scheme 1 shows in overview the synthesis pathways and intermediates used for preparing the compounds of the formula I in which A is the —CH₂O— bridge.

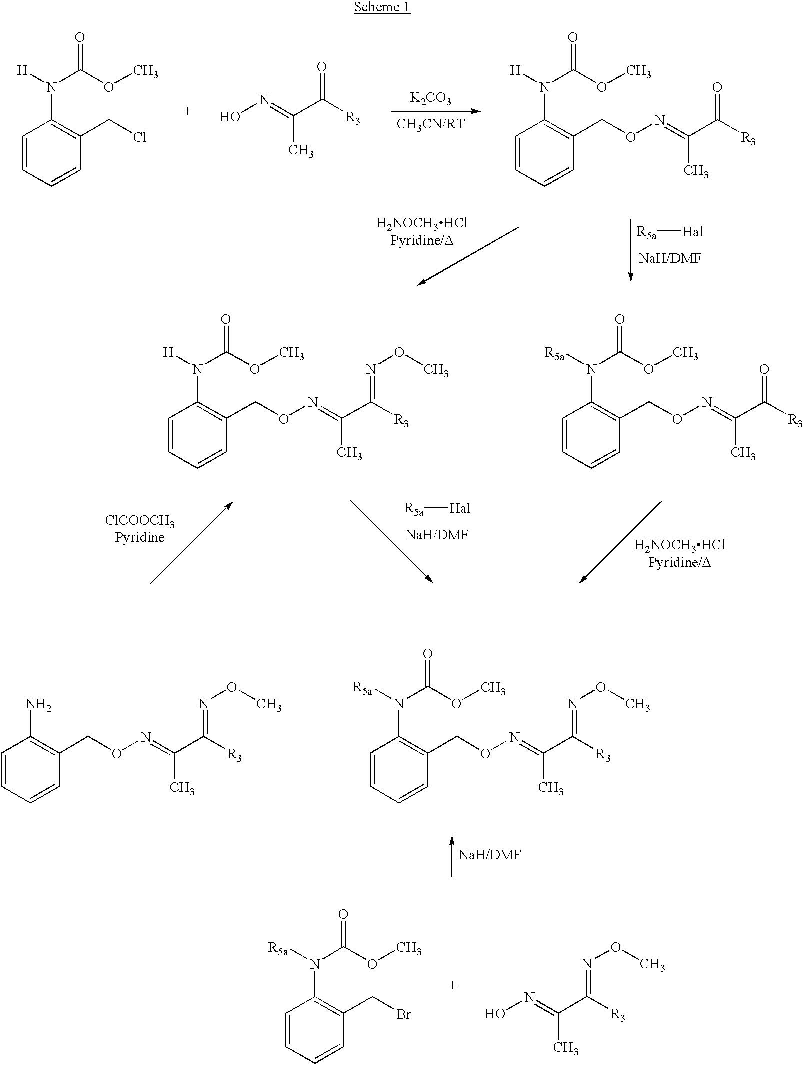

Physical data are reported in the subsequent tables

m.p. in ° Celsius; * isomers; Chem. shift in ¹H-NMR in ppm; t=triplet; q=quartet; s=singlet; br=broad

### Example Z1

### Methyl (2-formylphenyl)methylcarbamate

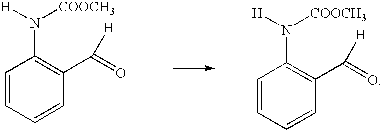

A solution of 2.6 g of methyl (2-formylphenyl)carbamate (J. Org. Chem. 1998, 63(23), 8515) in 10 ml of dimethylformamide is added dropwise at room temperature to a suspension of 0.64 g of sodium hydride (55% in oil) in 15 ml of dimethylformamide and the mixture is subsequently stirred at room temperature for 15 minutes. Then 2.2 g of methyl iodide are added and the reaction mixture is stirred at room temperature for 1 hour. The reaction mixture is worked up by being acidified with acetic acid and concentrated under a high vacuum. The residue is taken up in ethyl acetate, washed twice with water and twice with saturated sodium chloride solution, dried over sodium sulphate and concentrated by evaporation under vacuum. The crude product is purified by column chromatography (silica gel; ethyl acetate:hexane=1:3). This gives the desired methyl (2-formylphenyl)methylcarbamate as an oil.

¹H-NMR(CDCl₃): inter alia 3.46 (s); 10.1 (s).

The following compounds as well are prepared analogously:

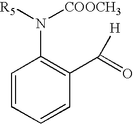

| R₅ | Phys. data | ¹H-NMR(CDCl₃) |
|---|---|---|
| C₂H₅ | Oil | i.a. 1.18 (t); 3.78 (q); 10.2 (s) |
| HC≡C—CH₂— | Oil | i.a. 2.28 (t); 4.48 (br); 10.13 (s) |
| H₃C—O—CH₂— | Oil | i.a. 3.52 (br); 4.96 (br); 10.0 (s) |

### Example Z2

### Methyl {2-[2-(4-fluorophenyl)-1-methyl-2-oxo-(E)-ethylideneaminooxymethyl]phenyl}carbamate

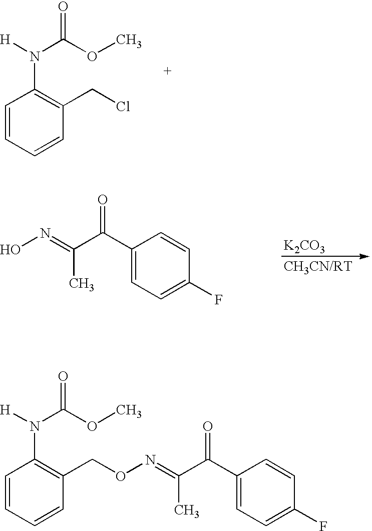

9.0 g of 1-(4-fluorophenyl)propane-1,2-dione 2-(E)-oxime and 6.9 g of potassium carbonate are introduced in 150 ml of acetonitrile. After 15 minutes, 10.0 g of methyl (2-chloromethylphenyl)carbamate (Fujisawa Pharm., EP-A-268989) are added with stirring. After two hours, the mixture is evaporated to dryness, the residue is partitioned between water and ethyl acetate and the residue from the evaporated organic phase is purified on silica gel using ethyl acetate/hexane (1:4 volume fractions) as eluent. This gives 1 g of methyl {2-[2-(4-fluorophenyl)-1-methyl-2-oxo-(E)-ethylideneaminooxymethyl]phenyl}carbamate in the form of colourless crystals (m.p. 71-73° C.).

### Example Z3

### Methyl {2-[2-(4-fluorophenyl)-1-methyl-2-oxo-(E)-ethylideneaminooxymethyl]phenyl}methylcarbamate

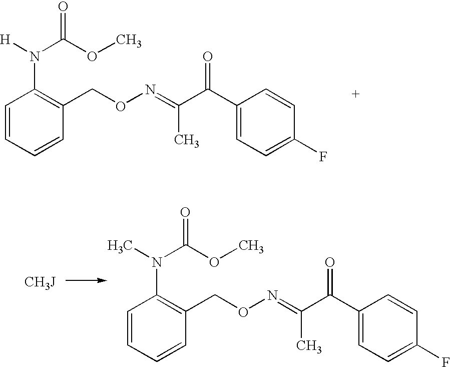

1.72 g of methyl {2-[2-(4-fluorophenyl)-1-methyl-2-oxo-(E)-ethylideneaminooxymethyl]phenyl}carbamate are added in portions with stirring to a suspension of 0.2 g of sodium hydride (approximately 60% in mineral oil) in 5 ml of dimethylformamide. After the end of evolution of hydrogen, the mixture is cooled in an ice-water bath and 0.31 ml of methyl iodide is added dropwise. After the mixture has been stirred at room temperature for two hours, ice-water is added and the product is extracted with ethyl acetate. The residue of the evaporated organic phase is purified on silica gel using ethyl acetate/hexane (1:5 volume fractions) as eluent. This gives methyl {2-[2-(4-fluorophenyl)-1-methyl-2-oxo-(E)-ethylideneaminooxymethyl]phenyl}methylcarbamate as a colourless oil.

¹H-NMR(CDCl₃): inter alia 3.59 (s) and 3.76 (s): NCH₃ (rotamers 3:1).

### Example Z4

### 2-[2-(2-Methoxyimino-1-methylpropylideneaminooxymethyl)]aniline

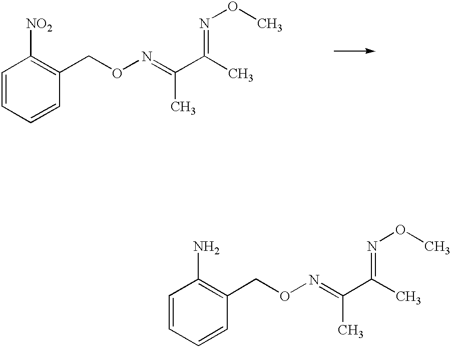

A suspension of 23.29 g of iron powder, 30 ml of water, 0.5 ml of concentrated hydrochloric acid and 150 ml of ethanol is heated to boiling temperature. After the heating source has been removed, 34.57 g of 2-[2-(2-methoxyimino-1-methylpropylideneaminooxymethyl)]nitrobenzene are added in portions with stirring and under nitrogen in such a way that the reaction solution remains at boiling temperature. After subsequently stirring at room temperature for 1.5 hours, the reaction mixture is filtered over Celite and the filtrate is concentrated by evaporation. Recrystallization of the residue from tert-butanol gives the desired 2-[2-(2-methoxyimino-1-methylpropylideneaminooxymethyl)]aniline as pale yellow crystals (m.p. 90-91° C.).

### Example Z5

### Methyl N-ethyl-[2-(2-hydroxyimino-1-methylpropylideneaminooxymethyl)phenyl]carbamate

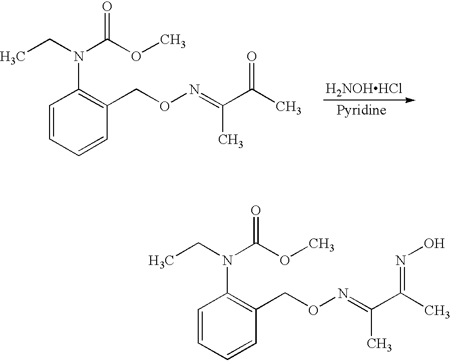

A solution of 710 mg of methyl ethyl[2-(1-methyl-2-oxo-propylideneaminooxymethyl)phenyl]carbamate, 280 mg of hydroxylamine hydro chloride and 0.3 ml of pyridine in 10 ml of ethanol is stirred at room temperature for 22 hours. The mixture is partitioned between ethyl acetate and half-saturated sodium chloride solution and the oil which remains after evaporating off the organic solvent is purified on silica gel using ethyl acetate/hexane (1:4 volume fractions) as eluent. The chromatographed oil can be crystallized from toluene/heptane (1:1 volume fractions). This gives methyl N-ethyl-[2-(2-hydroxyimino-1-methylpropylidene aminooxymethyl)phenyl]carbamatein isomerically pure form as pale yellow crystals (m.p. 84-85° C.).

### Example H1

### Methyl N-methyl-[2-({2-ethoxyimino-1-methyl-2-[4-(4-trifluoromethylphenoxy)phenyl]ethylidene}hydrazonomethyl)phenyl]carbamate

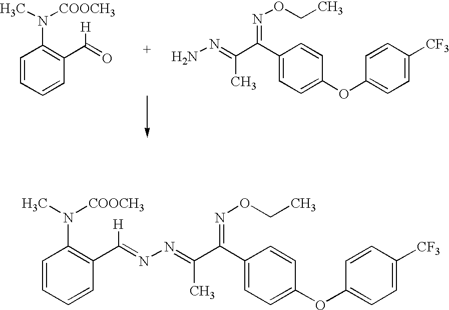

A mixture of 1.32 g of 2-hydrazono-1-[4-(4-trifluoromethylphenoxy)phenyl]propan-1-one O-ethyl oxime and 0.7 g of methyl N-methyl-(2-formylphenyl)carbamate in 6 ml of methanol is stirred at room temperature for 45 minutes. The reaction mixture is worked up by being concentrated under vacuum and the crude product is purified by column chromatography (silica gel; ethyl acetate:hexane=1:3). This gives the desired methyl N-methyl-[2-(f{2-ethoxyimino-1-methyl-2-[4-(4-trifluoromethyl phenoxy)phenyl]ethylidene}hydrazonomethyl)phenyl]carbamate as a resin.

The following compounds as well are prepared analogously:

TABLE a

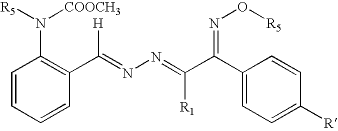

| | | | | | Phys. | ¹H-NMR of R₁ |
|---|---|---|---|---|---|---|
| No. | R₅ | R₁ | R₂ | R′ | Data | (CDCl₃) |
| 1 | CH₃ | CH₃ | C₂H₅ | 4-CF₃—C₆H₄—O— | Resin | 2.29 (s)¹ |
| 2 | C₂H₅ | CH₃ | C₂H₅ | 4-CF₃—C₆H₄—O— | Resin | 2.27 (s)¹ |
| 3 | C₂H₅ | C₂H₅ | C₂H₅ | 4-CF₃—C₆H₄—O— | Resin | 1.01(t); 2.28(q)¹ |
| 4 | CH₃ | C₂H₅ | C₂H₅ | 4-CF₃—C₆H₄—O— | Resin | 1.11(t); 2.81(q)¹ |
| 5 | H₃C—O—CH₂— | CH₃ | C₂H₅ | 4-CF₃—C₆H₄—O— | Resin | 2.28 (s)¹ |
| 6 | HC≡C—CH₂— | CH₃ | CH₃ | 4-CF₃—C₆H₄—O— | Resin | 2.31 (s) |
| 7 | HC≡C—CH₂— | CH₃ | C₂H₅ | 4-CF₃—C₆H₄—O— | Resin | 2.32 (s) |
| 8 | HC≡C—CH₂— | C₂H₅ | CH₃ | 4-CF₃—C₆H₄—O— | Resin* | 1.16(t); 2.88(q) |
| | | | | | | 1.24(t); 2.51(q) |
| 9 | HC≡C-CH₂— | C₂H₅ | C₂H₅ | 4-CF₃—C₆H₄—O— | Resin | 1.17(t); 2.91(q) |
| 10 | CH₃ | CH₃ | CH₃ | Cl | 116-118° | |
| 11 | CH₃ | CH₃ | CH₃ | F | 129-131° | |
| 12 | H₃C—O—CH₂— | CH₃ | CH₃ | Cl | 106-131° | |
| 13 | H₃C—O—CH₂— | CH₃ | CH₃ | F | 142-144° | |
| 14 | CH₃ | CH₃ | CH₃ | 3-CF₃O—C₆H₄—O— | Resin | 2.32 (s) |
| 15 | CH₃ | C₂H₅ | CH₃ | 3-CF₃O—C₆H₄—O— | Resin | 1.26(t); 2.89(q) |
| 16 | CH₃ | C₂H₅ | C₂H₅ | 43CF₃O—C₆H₄—O— | Resin | 1.26(t); 2.91(q) |
| 17 | CH₃ | CH₃ | CH₃ | 4-Cl—C₆H₄—O— | Resin | 2.32 (s) |
| 18 | CH₃ | CH₃ | C₂H₅ | 4-Cl—C₆H₄—O— | Resin | 2.33 (s) |

¹⁾ in DMSO-d6

### Example H2

### Methyl [2-(2-(E)-methoxyimino-1-methyl-(E)-propylideneaminooxymethyl)phenyl]carbamate

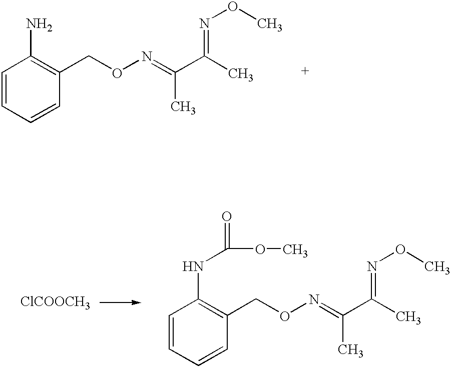

A solution of 9.41 g of 2-[2-(2-methoxyimino-1-methylpropylideneaminooxymethyl)]aniline and 3.54 ml of pyridine in 30 ml of dichloromethane is admixed with 3.1 ml of methyl chloroformate over 20 minutes with stirring and in the absence of oxygen. The temperature is maintained at +40° C. for 1.5 hours and then the product is washed with ice-water and the crystal cake which remains after the solvent has been evaporated off is recrystallized from tert-butanol. This gives methyl [2-(2-(E)-methoxyimino-1-methyl-(E)-propylideneaminooxymethyl)phenyl]carbamate in the form of colourless crystals (m.p. 96.5-97.5° C.).

### Example H3

### Methyl N-methoxymethyl-[2-(2-(E)-methoxyimino-1-methyl-(E)-propylideneaminooxymethyl)phenyl]carbamate

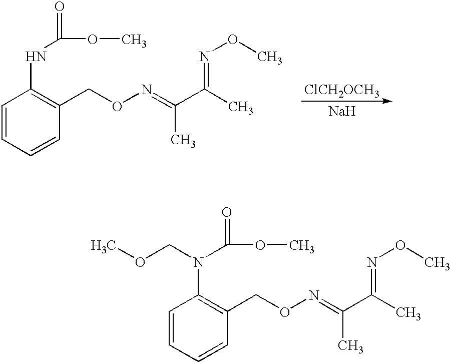

A solution of 2.93 g of methyl [2-(2-(E)-methoxyimino-1-methyl-(E)-propylideneaminooxymethyl)phenyl]carbamate in 5 ml of dimethylformamide is added dropwise with stirring and under nitrogen to a suspension of 300 mg of sodium hydride (as an 80% dispersion in white oil) in. 5 ml of dimethylformamide. After the end of evolution of hydrogen, the reaction solution is admixed with 0.84 ml of chloromethyl methyl ether, with ice cooling. After two hours, the reaction mixture is poured onto ice-water and extracted with ethyl acetate. Following the removal of the solvent by evaporation, the extract is purified on silica gel using ethyl acetate/hexane (1:4 volume fractions) as eluent. This gives methyl N-methoxytnethyl-[2-(2-(E)-methoxyimino-1-methyl-(E)-propylideneaminooxymethyl)phenyl]carbamate in the form of colourless crystals (m.p. 103-104° C.).

### Example H4

### Methyl N-ethyl-[2-(2-(E)-methoxyimino-1-methyl-(E)-propylideneaminooxymethyl)phenyl]carbamate

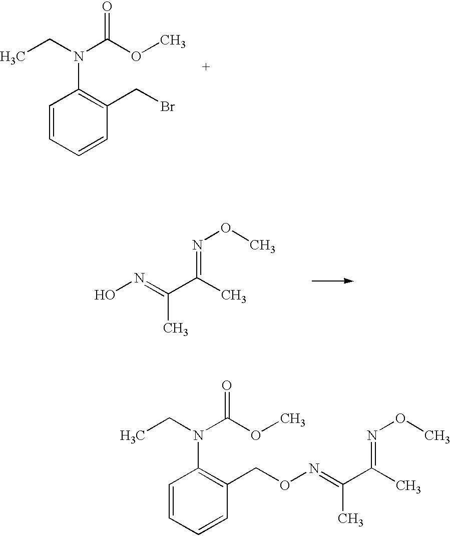

A solution of 3.1 g of methyl (2-bromomethylphenyl)ethylcarbamate (approximately 50% strength) and 911 mg of butane-2,3-dione (E)-O-methyloxime (E)-oxime in 10 ml of dimethylformamide is added with stirring and under nitrogen, and with ice cooling, to a suspension of 369 mg of sodium hydnrde (as an 80% dispersion in white oil) and one spatula tip of potassium iodide in 10 ml of dimethylformamide. After subsequent stirring at room temperature for 18 hours, the reaction mixture is partitioned between water and ethyl acetate. The residue obtained after the organic solvent has been distilled off is purified on silica gel using ethyl acetate/hexane (1:9 volume fractions) as eluent, with subsequent recrystallization from hexane. This gives methyl N-ethyl-[2-(2-(E)-methoxyimino-1-methyl-(E)-propylideneaminooxymethyl)phenyl]carbamate in the form of colourless crystals (m.p. 101-102° C.).

### Example H5

### Methyl N-methyl-{2-[2-(4-fluorophenyl)-2-(E/Z)-methoxyimino-1-methyl-(E)-ethylideneaminooxymethyl]phenyl}carbamate

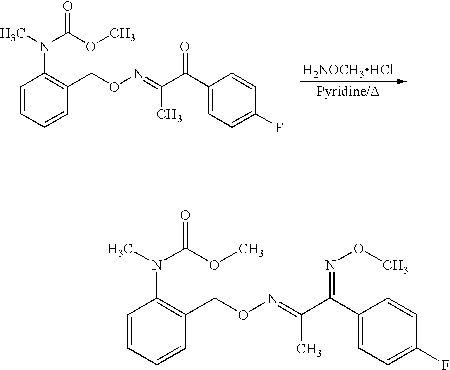

0.8 g of methyl N-methyl-{2-[2-(4-fluorophenyl)-1-methyl-2-oxo-(E)-ethylideneaminooxymethyl]phenyl}carbamate, 0.42 g of O-methylhydroxylamine hydrochloride and 5 ml of pyridine are stirred at +60° C. for 4 hours. After cooling, ice-water is added and the product is extracted with ethyl acetate. The extract concentrated by evaporation is purified on silica gel using ethyl acetate/hexane (1:2 volume fractions) as eluent. This gives methyl N-methyl-{2-[2-(4-fluorophenyl)-2-(E/Z)-methoxyimino-1-methyl-(E)-ethylidencaminooxymethyl]phenyl}carbamate as an isomer mixture in the form of a yellowish resin.

¹H-NMR(CDCl₃): inter alia 3.06 (s) and 3.20 (s): NCH₃.

### Example H6

### Methyl {2-[2-(4-fluorophenyl)-2-(E)-methoxyimino-1-methyl-(Z)-ethylideneaminooxymethyl]phenyl}carbamate

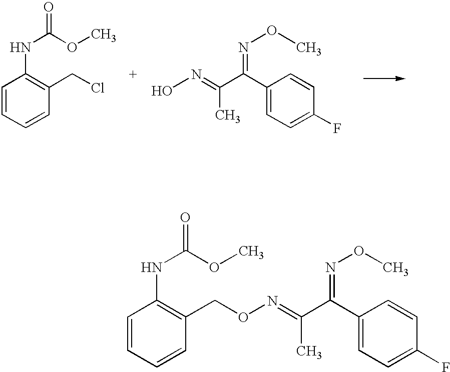

A mixture of 3.0 g of methyl (2-chloromethylphenyl)carbamate (Fujisawa Pharm., EP-A-268989), 3.0 g of 1-(4-fluorophenyl)propane-1,2-dione 1-(E)-O-methyloxime 2-(Z)-oxime and 2.1 g of potassium carbonate in 50 ml of acetonitrile is stirred at room temperature for 20 hours. After the solvent has been evaporated off, the residue is partitioned between water and ethyl acetate and the residue of the organic phase is purified on silica gel using ethyl acetate/bexane (from 1:4 to 1:2 volume fractions) as eluent. This gives methyl {2-[2-(4-fluorophenyl)-2-(E)-methoxyimino-1-methyl-(Z)-ethylideneaminooxymethyl]phenyl}carbamate in the form of colourless crystals (m.p. 143-144° C.).

### Example H7

### Methyl {2-[2-(4-fluorophenyl)-2-(E/Z)-methoxyimino-1-methyl-(E)-ethylideneaminooxymethyl]phenyl}carbamate

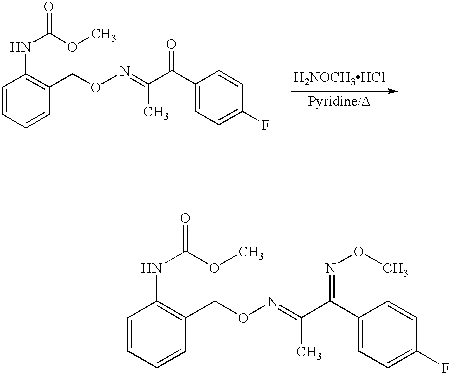

6.9 g of methyl {2-[2-(4-fluorophenyl)-1-methyl-2-oxo-(E)-ethylideneaminooxymethyl]phenyl}carbamate, 2.5 g of O-methylhydroxylamine hydrochloride and 25 ml of pyridine are held at +70° C. for 4 hours with stirring. After cooling, the mixture is poured onto ice-water and extracted with ethyl acetate. Distillative removal of ethyl acetate and pyridine residues gives methyl {2-[2-(4-fluorophenyl)-2-(E/Z)-methoxyimino-1-methyl-(E)-ethylideneaminooxymethyl]phenyl}carbamate as an isomer mixture in the form of a yellowish resin.

¹H-NMR(CDCl₃): inter alia 4.98 (s) and 5.06 (s): OCH₂phenyl.

### Example H8

### Methyl N-ethyl-{2-[2-(4-fluorophenyl)-2-(E/Z)-methoxyimino-1-methyl-(E)-ethylideneaminooxymethyl]phenyl}carbamate

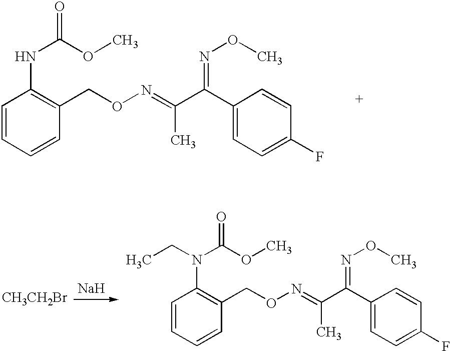

100 mg of sodium hydride (as an approximately 60% dispersion in mineral oil) are added with stirring in the absence of oxygen to a solution of 750 mg of methyl {2-[2-(4-fluorophenyl)-2-(E/Z)-methoxyimino-1-methyl-(E)-ethylideneaminooxymethyl]-phenyl}carbamate in 5 ml of dimethylformamide. After the end of evolution of hydrogen, ethyl bromide is added dropwise at room temperature, the reaction mixture is stirred for 2 hours, ice-water is added and the mixture is extracted with ethyl acetate. The extract concentrated by evaporation is purified on silica gel using ethyl acetate/hexane (1:2 volume fractions) as eluent. This gives methyl N-ethyl-{2-[2-(4-fluorophenyl)-2-(E/Z)-methoxyimino-1-methyl-(E)-ethylideneaminooxymethyl]-phenyl}carbamate as a mixture of two isomers in the form of a yellowish resin.

¹H-NMR(CDCl₃): inter alia 4.95 (q) and 5.12 (q): OCH₂phenyl.

The following compounds as well are prepared analogously:

TABLE b

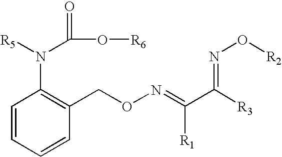

| No. | R₅ | R₁ | R₂ | R₃ | R₆ | Phys. Data |
|---|---|---|---|---|---|---|
| 1 | H | CH₃ | CH₃ | CH₃ | CH₃ | 96.5-97.5° |
| 2 | H | CH₃ | CH₃ | C₆H₅ | CH₃ | Resin |
| 3 | H | CH₃ | CH₃ | 4-F—C₆H₄— | CH₃ | 143-144° |
| | | | | | | (Z, E isomer) |
| 4 | H | CH₃ | CH₃ | 4-F—C₆H₄— | CH₃ | Resin* |
| | | | | | | (E, E/E, Z |
| | | | | | | mixture) |
| 5 | H | CH₃ | CH₃ | CH₃ | C₄H₉-t | Resin* |
| 6 | CH₃ | CH₃ | CH₃ | 4-F—C₆H₄— | CH₃ | Resin* |
| 7 | C₂H₅ | CH₃ | CH₃ | CH₃ | CH₃ | 101-102° |
| 8 | C₂H₅ | CH₃ | CH₃ | 4-F—C₆H₄— | CH₃ | Resin* |
| 9 | CH₃—O—CH₂— | CH₃ | CH₃ | CH₃ | CH₃ | 103-104° |
| 10 | H | CH₃ | C₂H₅ | 4-CF₃—C₆H₄-4- | CH₃ | 150-152° |
| | | | | O—C₆H₄— | | |
| 11 | CH₃ | CH₃ | C₂H₅ | 4-CF₃—C₆H₄-4- | CH₃ | Resin |
| | | | | O—C₆H₄— | | |

The compounds of the following tables may be prepared analogously.

Table 1

Compounds of the general formula I.1 in which R₂, R₅ and R₆ are methyl and R₃ corresponds in each case to one line of table A.

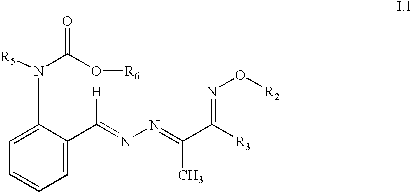

Table 2

Compounds of the general formula I.1 in which R₂ is ethyl and R₅ and R₆ are methyl and R₃ corresponds in each case to one line of table A.

Table 3

Compounds of the general formula I.1 in which R₂ is difluoromethyl and R₅ and R₆ are methyl and R₃ corresponds in each case to one line of table A.

Table 4

Compounds of the general formula I.1 in which R₂ is 2,2,2-trifluoroethyl and R₅ and R₆ are methyl and R₃ corresponds in each case to one line of table A.

Table 5

Compounds of the general formula I.1 in which R₂ and R₆ are methyl and R₅ is ethyl and R₃ corresponds in each case to one line of table A.

Table 6

Compounds of the general formula I.1 in which R₂ and R₆ are ethyl and R₅ is methyl and R₃ corresponds in each case to one line of table A.

Table 7

Compounds of the general formula I.1 in which R₂ and R₅ are ethyl and R₆ is methyl and R₃ corresponds in each case to one line of table A.

Table 8

Compounds of the general formula I.1 in which R₂ is methyl and R₅ and R₆ are ethyl and R₃ corresponds in each case to one line of table A.

Table 9

Compounds of the general formula I.1 in which R₂, R₅ and R₆ are ethyl and R₃ corresponds in each case to one line of table A.

Table 10

Compounds of the general formula I.1 in which R₂ is n-propyl and R₅ and R₆ are methyl and R₃ corresponds in each case to one line of table A.

Table 11

Compounds of the general formula I.1 in which R₂ and R₆ are methyl and R₅ is methoxymethyl and R₃ corresponds in each case to one line of table A.

Table 12

Compounds of the general formula I.2 in which R₂, R₅ and R₆ are methyl and R₃ corresponds in each case to one line of table A.

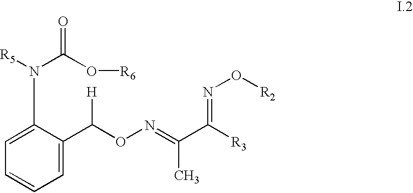

Table 13

Compounds of the general formula I.2 in which R₂ is ethyl and R₅ and R₆ are methyl and R₃ corresponds in each case to one line of table A.

Table 14

Compounds of the general formula I.2 in which R₂ is difluoromethyl and R₅ and R₆ are methyl and R₃ corresponds in each case to one line of table A.

Table 15

Compounds of the general formula I.2 in which R₂ is 2,2,2-trifluoroethyl and R₅ and R₆ are methyl and R₃ corresponds in each case to one line of table A.

Table 16

Compounds of the general formula I.2 in which R₂ and R₆ are methyl and R₅ is ethyl and R₃ corresponds in each case to one line of table A.

Table 17

Compounds of the general formula I.2 in which R₂ and R₅ are ethyl and R₆ is methyl and R₃ corresponds in each case to one line of table A.

Table 18

Compounds of the general formula I.2 in which R₂ and R₆ are ethyl and R₅ is methyl and R₃ corresponds in each case to one line of table A.

Table 19

Compounds of the general formula I.2 in which R₂ is methyl and R₅ and R₆ are ethyl and R₃ corresponds in each case to one line of table A.

Table 20

Compounds of the general formula I.2 in which R₂, R₅ and R₆ are ethyl and R₃ corresponds in each case to one line of table A.

Table 21

Compounds of the general formula I.2 in which R₂ is n-propyl and R₅ and R₆ are methyl and R₃ corresponds in each case to one line of table A.

Table 22

Compounds of the general formula I.2 in which R₂ and R₆ are methyl and R₅ is methoxymethyl and R₃ corresponds in each case to one line of table A.

Table 23

Compounds of the general formula I.3 in which R₂, R₅ and R₆ are methyl and R₃ corresponds in each case to one line of table A.

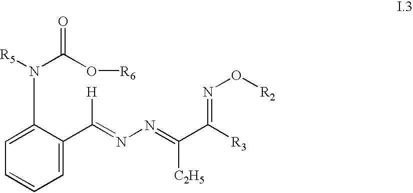

Table 24

Compounds of the general formula I.3 in which R₂ is ethyl and R₅ and R₆ are methyl and R₃ corresponds in each case to one line of table A.

Table 25

Compounds of the general formula I.3 in which R₂ is difluoromethyl and R₅ and R₆ are methyl and R₃ corresponds in each case to one line of table A.

Table 26

Compounds of the general formula I.3 in which R₂ is 2,2,2-trifluoroethyl and R₅ and R₆ are methyl and R₃ corresponds in each case to one line of table A.

Table 27

Compounds of the general formula I.3 in which R₂ and R₆ are methyl and R₅ is ethyl and R₃ corresponds in each case to one line of table A.

Table 28

Compounds of the general formula I.3 in which R₂ and R₅ are ethyl and R₆ is methyl and R₃ corresponds in each case to one line of table A.

Table 29

Compounds of the general formula I.3 in which R₂ and R₆ are ethyl and R₅ is methyl and R₃ corresponds in each case to one line of table A.

Table 30

Compounds of the general formula I.3 in which R₂ is methyl and R₅ and R₆ are ethyl and R₃ corresponds in each case to one line of table A.

Table 31

Compounds of the general formula I.3 in which R₂, R₅ and R₆ are ethyl and R₃ corresponds in each case to one line of table A.

Table 32

Compounds of the general formula I.3 in which R₂ is n-propyl and R₅ and R₆ are methyl and R₃ corresponds in each case to one line of table A.

Table 33

Compounds of the general formula I.3 in which R₂ and R₆ are methyl and R₅ is methoxymethyl and R₃ corresponds in each case to one line of table A.

Table 34

Compounds of the general formula I.4 in which R₂, R₅ and R₆ are methyl and R₃ corresponds in each case to one line of table A.

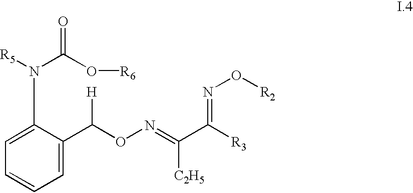

Table 35

Compounds of the general formula I.4 in which R₂ is ethyl and R₅ and R₆ are methyl and R₃ corresponds in each case to one line of table A.

Table 36

Compounds of the general formula I.4 in which R₂ is difluoromethyl and R₅ and R are methyl and R₃ corresponds in each case to one line of table A.

Table 37

Compounds of the general formula I.4 in which R₂ is 2,2,2-trifluoroethyl and R₅ and R₆ are methyl and R₃ corresponds in each case to one line of table A.

Table 38

Compounds of the general formula I.4 in which R₂ and R₆ are methyl and R₅ is ethyl and R₃ corresponds in each case to one line of table A.

Table 39

Compounds of the general formula I.4 in which R₂ and R₅ are ethyl and R₆ is methyl and R₃ corresponds in each case to one line of table A.

Table 40

Compounds of the general formula I.4 in which R₂ and R₆ are ethyl and R₅ is methyl and R₃ corresponds in each case to one line of table A.

Table 41

Compounds of the general formula I.4 in which R₂ is methyl and R₅ and R₆ are ethyl and R₃ corresponds in each case to one line of table A.

Table 42

Compounds of the general formula I.4 in which R₂, R₅ and R₆ are ethyl and R₃ corresponds in each case to one line of table A.

Table 43

Compounds of the general formula I.4 in which R₂ is n-propyl and R₅ and R₆ are methyl and R₃ corresponds in each case to one line of table A.

Table 44

Compounds of the general formula I.4 in which R₂ and R₆ are methyl and R₅ is methoxymethyl and R₃ corresponds in each case to one line of table A.

Table 45

Compounds of the general formula I.5 in which R₁, R₂ and R₆ are methyl and R₃ corresponds in each case to one line of table A.

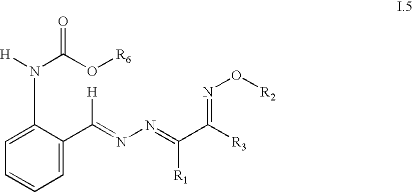

Table 46

Compounds of the general formula I.5 in which R₁ is ethyl and R₂ and R₆ are methyl and; R₃ corresponds in each case to one line of table A.

Table 47

Compounds of the general formula I.5 in which R₁ and R₂ are methyl and R₆ is ethyl and R₃ corresponds in each case to one line of table A.

Table 48

Compounds of the general formula I.5 in which R₁ and R₂ are ethyl and R₆ is methyl and R₃ corresponds in each case to one line of table A.

Table 49

Compounds of the general formula I.5 in which R₁ and R₆ are ethyl and R₂ is methyl and R₃ corresponds in each case to one line of table A.

Table 50

Compounds of the general formula I.5 in which R₁ is methyl and R₂ and R₆ are ethyl and R₃ corresponds in each case to one line of table A.

Table 51

Compounds of the general formula I.5 in which R₁, R₂ and R₆ are ethyl and R₃ corresponds in each case to one line of table A.

Table 52

Compounds of the general formula I.5 in which R₂ is n-propyl and R₁ and R₆ are methyl and R₃ corresponds in each, case to one line of table A.

Table 53

Compounds of the general, formula I.5 in which R₂ is n-propyl, R₁ is ethyl and R₆ is methyl and R₃ corresponds in each case to one line of table A.

Table 54

Compounds of the general formula I.6 in which R₁, R₂ and R₆ are methyl and R₃ corresponds in each case to one line of table A.

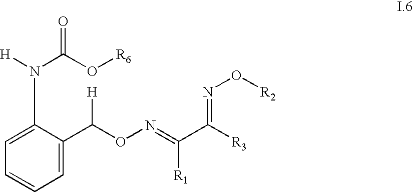

Table 55

Compounds of the general formula I.6 in which R₁ is ethyl and R₂ and R₆ are methyl and R₃ corresponds in each case to one line of table A.

Table 56

Compounds of the general formula I.6 in which R₁ and R₂ are methyl and R₆ is ethyl and R₃ corresponds in each case to one line of table A.

Table 57

Compounds of the general formula I.6 in which R₁ and R₂ are ethyl and 6 is methyl and R₃ corresponds in each case to one line of table A.

Table 58

Compounds of the general formula I.6 in which R₁ and R₆, are ethyl and R₂ is methyl and R₃ corresponds in each case to one line of table A.

Table 59

Compounds of the general formula I.6 in which R₁ is methyl and R₂ and R₆ are ethyl and R₃ corresponds in each case to one line of table A.

Table 60

Compounds of the general formula I.6 in which R₁, R₂ and R₆ are ethyl and R₃ corresponds in each case to one line of table A.

Table 61

Compounds of the general formula I.6 in which R₂ is n-propyl and R₁ and R₆ are methyl and R₃ corresponds in each case to one line of table A.

Table 62

Compounds of the general formula I.6 in which R₂ is n-propyl, R₁ is ethyl and R₆ is methyl and R₃ corresponds in each case to one line of table A.

TABLE A

| No. | R₃ |
|---|---|
| 1 | CH₃ |
| 2 | CH₂CH₃ |
| 3 | (CH₂)₂CH₃ |
| 4 | (CH₂)₃CH₃ |
| 5 | (CH₂)₄CH₃ |
| 6 | (CH₂)₅CH₃ |
| 7 | CH(CH₃)₂ |
| 8 | C(CH₃)₃ |
| 9 | CH₂CH(CH₃)₂ |
| 10 | CH(CH₃)CH₂CH₃ |
| 11 | OCH₃ |
| 12 | OCH₂CH₃ |
| 13 | O(CH₂)₂CH₃ |
| 14 | O(CH₂)₃CH₃ |
| 15 | O(CH₂)₄CH₃ |
| 16 | OCH(CH₃)₂ |
| 17 | OCH(CH₃)CH₂CH₃ |
| 18 | OC(CH₃)₃ |
| 19 | CH═CH₂ |
| 20 | CH═CHCH₃ |
| 21 | CH═C(CH₃)₂ |
| 22 | CH₂CH═CH₂ |
| 23 | CH₂CH═CHCH₃ |
| 24 | OCH₂CH═CH₂ |
| 25 | C≡CH |
| 26 | C≡CCH₃ |
| 27 | C≡CC(CH₃)₃ |
| 28 | CH₂C≡CH |
| 29 | CH₂C≡CCH₃ |
| 30 | OCH₂C≡CH₃ |
| 31 | OCH₂C≡C—C(CH₃)₃ |
| 32 | C(O)OCH₃ |
| 33 | C(O)OCH₂CH₃ |
| 34 | C(O)O(CH₂)₂CH₃ |
| 35 | C(O)O(CH₂)₃CH₃ |
| 36 | C(O)O(CH₂)₄CH₃ |
| 37 | C(O)OCH(CH₃)₂ |
| 38 | C(O)OC(CH₃)₃ |
| 39 | CN |
| 40 | Cl |
| 41 | Br |
| 42 | CF₃ |
| 43 | CH₂CF₃ |
| 44 | CH₂CH₂F |
| 45 | CH₂CN |
| 46 | CH₂OCH₃ |
| 47 | CH₂OCH₂CH₃ |
| 48 | (CH₂)₂COOCH₃ |
| 49 | (CH₂)₂CONH₂ |
| 50 | (CH₂)₂CONHCH₃ |
| 51 | (CH₂)₂CON(CH₃)₂ |
| 52 | (CH₂)₂SCH₃ |
| 53 | CH₂OCH₂CH═CH₂ |
| 54 | 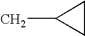 |
| 55 | 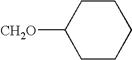 |
| 56 | CH═CF₂ |
| 57 | C≡C—Br |
| 58 | C≡C—OCH₃ |
| 59 | C₃H₅-cyclo |
| 60 | C₄H₇-cyclo |
| 61 | C₅H₉-cyclo |
| 62 | C₆H₁₁-cyclo |
| 63 | C₆H₅ |
| 64 | 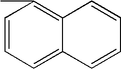 |
| 65 | 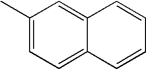 |
| 66 | 2-F—C₆H₄ |
| 67 | 3-F—C₆H₄ |
| 68 | 4-F—C₆H₄ |
| 69 | 2,3-F₂—C₆H₃ |
| 70 | 2,4-F₂—C₆H₃ |
| 71 | 2,5-F₂—C₆H₃ |
| 72 | 2,6-F₂—C₆H₃ |
| 73 | 3,4-F₂—C₆H₃ |
| 74 | 3,5-F₂—C₆H₃ |
| 75 | 2-Cl—C₆H₄ |
| 76 | 3-Cl—C₆H₄ |
| 77 | 4-Cl—C₆H₄ |
| 78 | 2,3-Cl₂—C₆H₃ |
| 79 | 2,4-Cl₂—C₆H₃ |
| 80 | 2,5-Cl₂—C₆H₃ |
| 81 | 2,6-Cl₂—C₆H₃ |
| 82 | 3,4-Cl₂—C₆H₃ |
| 83 | 3,5-Cl₂—C₆H₃ |
| 84 | 2,3,4-Cl₃—C₆H₂ |
| 85 | 2,3,5-Cl₃—C₆H₂ |
| 86 | 2,3,6-Cl₃—C₆H₂ |
| 87 | 2,4,5-Cl₃—C₆H₂ |
| 88 | 2,4,6-Cl₃—C₆H₂ |
| 89 | 3,4,5-Cl₃—C₆H₂ |
| 90 | 2-Br—C₆H₄ |
| 91 | 3-Br—C₆H₄ |
| 92 | 4-Br—C₆H₄ |
| 93 | 2,3-Br₂—C₆H₃ |
| 94 | 2,4-Br₂—C₆H₃ |
| 95 | 2,5-Br₂—C₆H₃ |
| 96 | 2,6-Br₂—C₆H₃ |
| 97 | 3,4-Br₂—C₆H₃ |
| 98 | 3,5-Br₂—C₆H₃ |
| 99 | 2-F-3-Cl—C₆H₃ |
| 100 | 2-F-4-Cl—C₆H₃ |
| 101 | 2-F-5-Cl—C₆H₃ |
| 102 | 2-F-3-Br—C₆H₃ |
| 103 | 2-F-4-Br—C₆H₃ |
| 104 | 2-F-5-Br—C₆H₃ |
| 105 | 2-Cl-3-Br—C₆H₃ |
| 106 | 2-Cl-3-Br—C₆H₃ |
| 107 | 2-Cl-5-Br—C₆H₃ |
| 108 | 3-F-4-Cl—C₆H₃ |
| 109 | 3-F-5-Cl—C₆H₃ |
| 110 | 3-F-6-Cl—C₆H₃ |
| 111 | 3-F-4-Br—C₆H₃ |
| 112 | 3-F-5-Br—C₆H₃ |
| 113 | 3-F-6-Br—C₆H₃ |
| 114 | 3-Cl-4-Br—C₆H₃ |
| 115 | 3-Cl-5-Br—C₆H₃ |
| 116 | 3-Cl-6-Br—C₆H₃ |
| 117 | 4-F-5-Cl—C₆H₃ |
| 118 | 4-F-6-Cl—C₆H₃ |
| 119 | 4-F-5-Br—C₆H₃ |
| 120 | 4-F-6-Br—C₆H₃ |
| 121 | 4-Cl-5-Br—C₆H₃ |
| 122 | 5-F-6-Cl—C₆H₃ |
| 123 | 5-F-6-Br—C₆H₃ |
| 124 | 5-Cl-6-Br—C₆H₃ |
| 125 | 3-Br-4-Cl-5-Br—C₆H₂ |
| 126 | 2-CN—C₆H₄ |
| 127 | 3-CN—C₆H₄ |
| 128 | 4-CN—C₆H₄ |
| 129 | 3-OCN—C₆H₄ |
| 130 | 4-OCN—C₆H₄ |
| 131 | 2-CH₃O—C₆H₄ |
| 132 | 3-CH₃O—C₆H₄ |
| 133 | 4-CH₃O—C₆H₄ |
| 134 | 2,3-(CH₃O)₂—C₆H₃ |
| 135 | 2,4-(CH₃O)₂—C₆H₃ |
| 136 | 2,5-(CH₃O)₂—C₆H₃ |
| 137 | 3,4-(CH₃O)₂—C₆H₃ |
| 138 | 3,5-(CH₃O)₂—C₆H₃ |
| 139 | 3,4,5-(CH₃O)₃—C₆H₂ |
| 140 | 2-C₂H₅O—C₆H₄ |
| 141 | 3-C₂H₅O—C₆H₄ |
| 142 | 4-C₂H₅O—C₆H₄ |
| 143 | 2-(n-C₃H₇O)—C₆H₄ |
| 144 | 3-(n-C₃H₇O)—C₆H₄ |
| 145 | 4-(n-C₃H₇O)—C₆H₄ |
| 146 | 2-(i-C₃H₇O)—C₆H₄ |
| 147 | 3-(i-C₃H₇O)—C₆H₄ |
| 148 | 4-(i-C₃H₇O)—C₆H₄ |
| 149 | 4-(n-C₄H₉O)—C₆H₄ |
| 150 | 3-(t-C₄H₉O)—C₆H₄ |
| 151 | 4-(t-C₄H₉O)—C₆H₄ |
| 152 | 2-(CH₂═CH—CH₂)—O—C₆H₄ |
| 153 | 3-(CH₂═CH—CH₂)—O—C₆H₄ |
| 154 | 4-(CH₂═CH—CH₂)—O—C₆H₄ |
| 155 | 2-CF₃—C₆H₄ |
| 156 | 3-CF₃—C₆H₄ |
| 157 | 4-CF₃—C₆H₄ |
| 158 | 2-(CH₃—CO)—C₆H₄ |
| 159 | 3-(CH₃—CO)—C₆H₄ |
| 160 | 4-(CH₃—CO)—C₆H₄ |
| 161 | 2-(CH₃—O—CO)—C₆H₄ |
| 162 | 3-(CH₃—O—CO)—C₆H₄ |
| 163 | 4-(CH₃—O—CO)—C₆H₄ |
| 164 | 2-(H₂N—CO)—C₆H₄ |
| 165 | 3-(H₂N—CO)—C₆H₄ |
| 166 | 4-(H₂N—CO)—C₆H₄ |
| 167 | 2-[(CH₃)₂N—CO]—C₆H₄ |
| 168 | 3-[(CH₃)₂N—CO]—C₆H₄ |
| 169 | 4-[(CH₃)₂N—CO]—C₆H₄ |
| 170 | 2-(CH₃—NH—CO)—C₆H₄ |
| 171 | 3-(CH₃—NH—CO)—C₆H₄ |
| 172 | 4-(CH₃—NH—CO)—C₆H₄ |
| 173 | 2-CH₃S—C₆H₄ |
| 174 | 3-CH₃S—C₆H₄ |
| 175 | 4-CH₃S—C₆H₄ |
| 176 | 2-CH₃SO₂—C₆H₄ |
| 177 | 3-CH₃SO₂—C₆H₄ |
| 178 | 4-CH₃SO₂—C₆H₄ |
| 179 | 2-CF₃O—C₆H₄ |
| 180 | 3-CF₃O—C₆H₄ |
| 181 | 4-CF₃O—C₆H₄ |
| 182 | 2-CHF₂O—C₆H₄ |
| 183 | 3-CHF₂O—C₆H₄ |
| 184 | 4-CHF₂O—C₆H₄ |
| 185 | 3-CF₃-4-CF₃O—C₆H₃ |
| 186 | 2-CH₃NH—C₆H₄ |
| 187 | 3-CH₃NH—C₆H₄ |
| 188 | 4-CH₃NH—C₆H₄ |
| 189 | 2-(CH₃)₂N—C₆H₄ |
| 190 | 3-(CH₃)₂N—C₆H₄ |
| 191 | 4-(CH₃)₂N—C₆H₄ |
| 192 | 2-(C₂H₅—O—CO)—C₆H₄ |
| 193 | 3-(C₂H₅—O—CO)—C₆H₄ |
| 194 | 4-(C₂H₅—O—CO)—C₆H₄ |
| 195 | 2-CH₂FCH₂—C₆H₄ |
| 196 | 3-CH₂FCH₂—C₆H₄ |
| 197 | 4-CH₂FCH₂—C₆H₄ |
| 198 | 2-CF₃CH₂—C₆H₄ |
| 199 | 3-CF₃CH₂—C₆H₄ |
| 200 | 4-CF₃CH₂—C₆H₄ |
| 201 | 2-CHF₂CF₂—C₆H₄ |
| 202 | 3-CHF₂CF₂—C₆H₄ |
| 203 | 4-CHF₂CF₂—C₆H₄ |
| 204 | 2-CHF₂—C₆H₄ |
| 205 | 3-CHF₂—C₆H₄ |
| 206 | 4-CHF₂—C₆H₄ |
| 207 | 2-NO₂—C₆H₄ |
| 208 | 3-NO₂—C₆H₄ |
| 209 | 4-NO₂—C₆H₄ |
| 210 | 2-CH₃—C₆H₄ |
| 211 | 3-CH₃—C₆H₄ |
| 212 | 4-CH₃—C₆H₄ |
| 213 | 2,3-(CH₃)₂—C₆H₃ |
| 214 | 2,4-(CH₃)₂—C₆H₃ |
| 215 | 2,5-(CH₃)₂—C₆H₃ |
| 216 | 2,6-(CH₃)₂—C₆H₃ |
| 217 | 3,4-(CH₃)₂—C₆H₃ |
| 218 | 3,5-(CH₃)₂—C₆H₃ |
| 219 | 2-C₂H₅—C₆H₄ |
| 220 | 3-C₂H₅—C₆H₄ |
| 221 | 4-C₂H₅—C₆H₄ |
| 222 | 2-i-C₃H₇—C₆H₄ |
| 223 | 3-i-C₃H₇—C₆H₄ |
| 224 | 4-i-C₃H₇—C₆H₄ |
| 225 | 3-t-C₄H₉—C₆H₄ |
| 226 | 4-t-C₄H₉—C₆H₄ |
| 227 | 2-(CH₂═CH)—C₆H₄ |
| 228 | 3-(CH₂═CH)—C₆H₄ |
| 229 | 4-(CH₂═CH)—C₆H₄ |
| 230 | 2-(CH₂═CH—CH₂)C₆H₄ |
| 231 | 3-(CH₂═CH—CH₂)—C₆H₄ |
| 232 | 4-(CH₂═CH—CH₂)—C₆H₄ |
| 233 | 2-(CH≡C—CH₂)—C₆H₄ |
| 234 | 2-(CH≡C)—C₆H₄ |
| 235 | 3-(CH≡C—CH₂)—O—C₆H₄ |
| 236 | 4-(CH≡C—CH₂CH₂)—O—C₆H₄ |
| 237 | 2-C₆H₅—C₆H₄ |
| 238 | 3-C₆H₅—C₆H₄ |
| 239 | 3-CH₃-5-t-C₄H₉—C₆H₃ |
| 240 | 2-F-4-CH₃—C₆H₃ |
| 241 | 2-F-5-CH₃—C₆H₃ |
| 242 | 2-CH_{3-4-F—C}₆H₃ |
| 243 | 2-CH_{3-5-F—C}₆H₃ |
| 244 | 2-CH_{3-4-Cl—C}₆H₃ |
| 245 | 2-F-4-CH₃—O—C₆H₃ |
| 246 | 2-F-4-CH₃CH₂O—C₆H₃ |
| 247 | 2-F-4-i-C₃H₇—C₆H₃ |
| 248 | 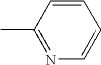 |
| 249 | 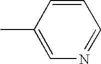 |
| 250 | 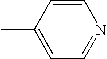 |
| 251 | 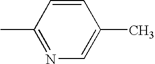 |
| 252 | 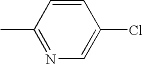 |
| 253 | 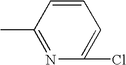 |
| 254 | 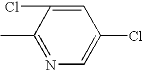 |
| 255 | 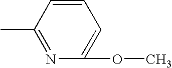 |
| 256 | 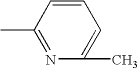 |
| 257 | 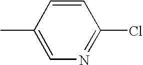 |
| 258 | 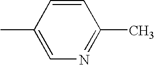 |
| 259 | 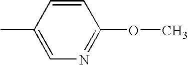 |
| 260 | 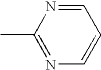 |
| 261 | 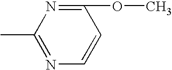 |
| 262 | 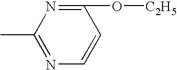 |
| 263 | 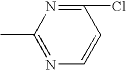 |
| 264 | 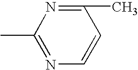 |
| 265 | 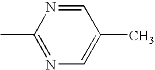 |
| 266 | 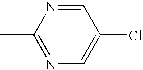 |
| 267 | 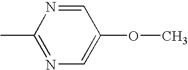 |
| 268 | 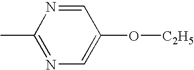 |
| 269 | 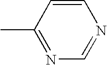 |
| 270 | 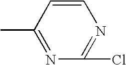 |
| 271 | 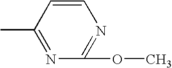 |
| 272 | 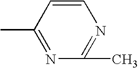 |
| 273 | 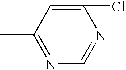 |
| 274 | 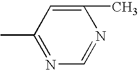 |
| 275 | 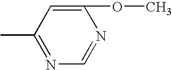 |
| 276 | 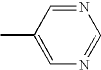 |
| 277 | 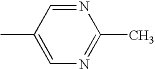 |
| 278 | 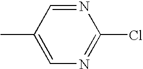 |
| 279 | 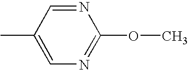 |
| 280 | 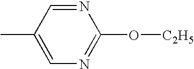 |
| 281 | 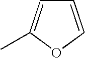 |
| 282 | 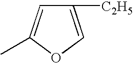 |
| 283 | 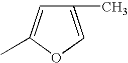 |
| 284 | 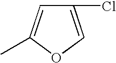 |
| 285 | 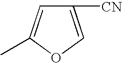 |
| 286 | 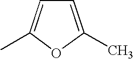 |
| 287 | 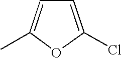 |
| 288 | 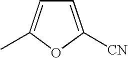 |
| 289 | 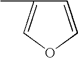 |
| 290 | 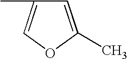 |
| 291 | 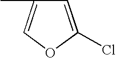 |
| 292 | 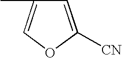 |
| 293 | 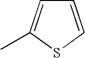 |
| 294 | 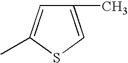 |
| 295 | 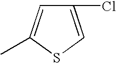 |
| 296 | 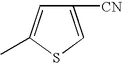 |
| 297 | 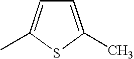 |
| 298 | 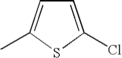 |
| 299 | 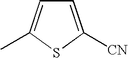 |
| 300 | 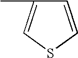 |
| 301 | 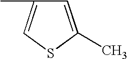 |
| 302 | 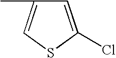 |
| 303 | 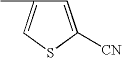 |
| 304 | 1-Methylprop-2-yl |
| 305 | 1-Methylprop-3-yl |
| 306 | 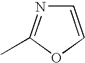 |
| 307 | 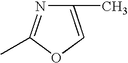 |
| 308 | 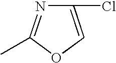 |
| 309 | 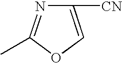 |
| 310 | 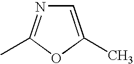 |
| 311 | 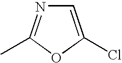 |
| 312 | 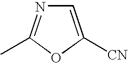 |
| 313 | 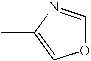 |
| 314 | 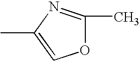 |
| 315 | 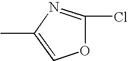 |
| 316 | 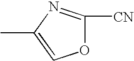 |
| 317 | 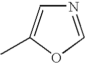 |
| 318 | 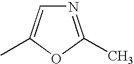 |
| 319 | 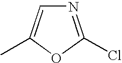 |
| 320 | 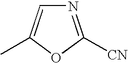 |
| 321 | 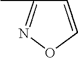 |
| 322 | 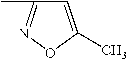 |
| 323 | 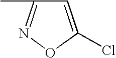 |
| 324 | 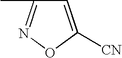 |
| 325 | 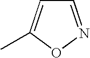 |
| 326 | 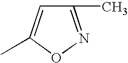 |
| 327 | 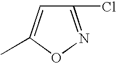 |
| 328 | 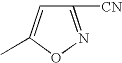 |
| 329 | 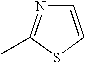 |
| 330 | 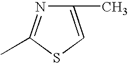 |
| 331 | 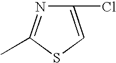 |
| 332 | 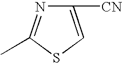 |
| 333 | 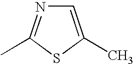 |
| 334 | 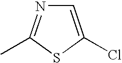 |
| 335 | 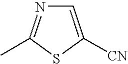 |
| 336 | 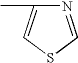 |
| 337 | 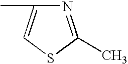 |
| 338 | 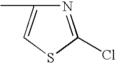 |
| 339 | 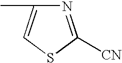 |
| 340 | 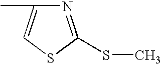 |
| 341 | 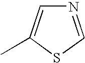 |
| 342 | 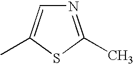 |
| 343 | 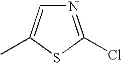 |
| 344 | 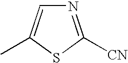 |
| 345 | 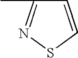 |
| 346 | 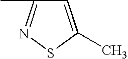 |
| 347 | 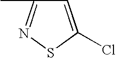 |
| 348 | 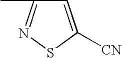 |
| 349 | 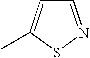 |
| 350 | 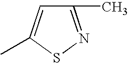 |
| 351 | 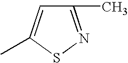 |
| 352 | 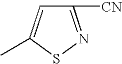 |
| 353 | 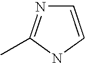 |
| 354 | 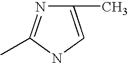 |
| 355 | 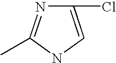 |
| 356 | 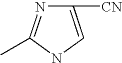 |
| 357 | 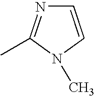 |
| 358 | 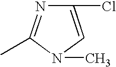 |
| 359 | 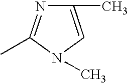 |
| 360 | 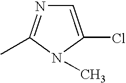 |
| 361 | 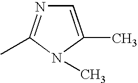 |
| 362 | 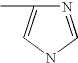 |
| 363 | 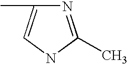 |
| 364 | 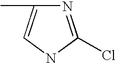 |
| 365 | 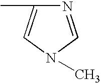 |
| 366 | 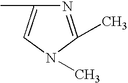 |
| 367 | 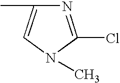 |
| 368 | 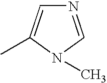 |
| 369 | 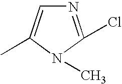 |
| 370 | 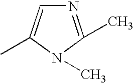 |
| 371 | 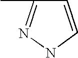 |
| 372 | 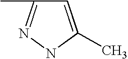 |
| 373 | 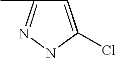 |
| 374 | 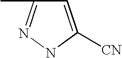 |
| 375 | 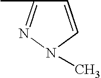 |
| 376 | 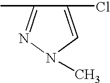 |
| 377 | 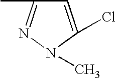 |
| 378 | 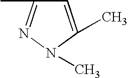 |
| 379 | 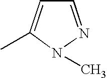 |
| 380 | 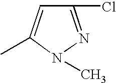 |
| 381 | 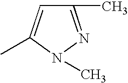 |
| 382 | 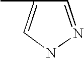 |
| 383 | 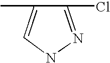 |
| 384 | 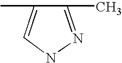 |
| 385 | 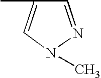 |
| 386 | 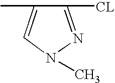 |
| 387 | 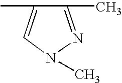 |
| 388 | 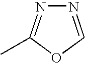 |
| 389 | 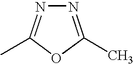 |
| 390 | 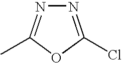 |
| 391 | 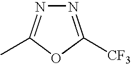 |
| 392 | 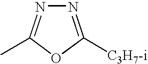 |
| 393 | 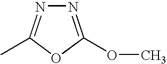 |
| 394 | 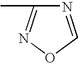 |
| 395 | 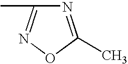 |
| 396 | 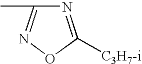 |
| 397 | 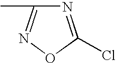 |
| 398 | 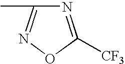 |
| 399 | 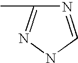 |
| 400 | 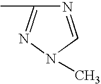 |
| 401 | 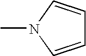 |
| 402 | 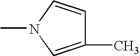 |
| 403 | 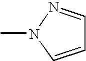 |
| 404 | 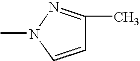 |
| 405 | 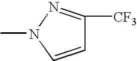 |
| 406 | 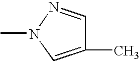 |
| 407 | 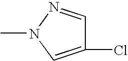 |
| 408 | 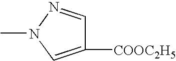 |
| 409 | 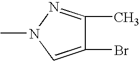 |
| 410 | 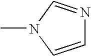 |
| 411 | 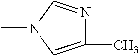 |
| 412 | 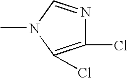 |
| 413 | 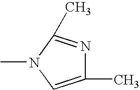 |
| 414 | 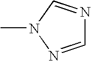 |
| 415 | 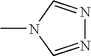 |
| 416 | 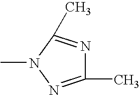 |
| 417 | 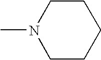 |
| 418 | 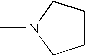 |
| 419 | 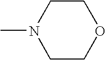 |
| 420 | 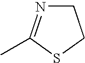 |
| 421 | 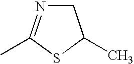 |
| 422 | 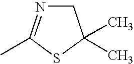 |
| 423 | 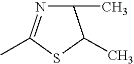 |
| 424 | 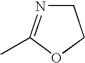 |
| 425 | 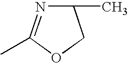 |
| 426 | 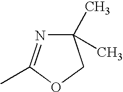 |
| 427 | 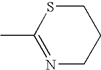 |
| 428 | 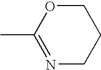 |
| 429 | 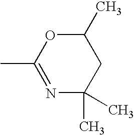 |
| 430 | C₃H_{5-cycl-O—} |
| 431 | C₄H₇-cycl-O— |
| 432 | C₅H₉-cycl-O— |
| 433 | C₆H₁₁-cycl-O— |
| 434 | C₆H_{5-O—} |
| 435 | 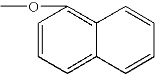 |
| 436 | 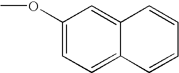 |
| 437 | 2-F—C₆H₄O |
| 438 | 3-F—C₆H₄O |
| 439 | 4-F—C₆H₄O |
| 440 | 2,3-F₂—C₆H₃O |
| 441 | 2,4-F₂—C₆H₃O |
| 442 | 2,5-F₂—C₆H₃O |
| 443 | 2,6-F₂—C₆H₃O |
| 444 | 3,4-F₂—C₆H₃O |
| 445 | 3,5-F₂—C₆H₃O |
| 446 | 2-Cl—C₆H₄O |
| 447 | 3-Cl—C₆H₄O |
| 448 | 4-Cl—C₆H₄O |
| 449 | 2,3-Cl₂—C₆H₃O |
| 450 | 2,4-Cl₂—C₆H₃O |
| 451 | 2,5-Cl₂—C₆H₃O |
| 452 | 2,6-Cl₂—C₆H₃O |
| 453 | 3,4-Cl₂—C₆H₃O |
| 454 | 3,5-Cl₂—C₆H₃O |
| 455 | 2,3,4-Cl₃—C₆H₂O |
| 456 | 2,3,5-Cl₃—C₆H₂O |
| 457 | 2,3,6-Cl₃—C₆H₂O |
| 458 | 2,4,5-Cl₃—C₆H₂O |
| 459 | 2,4,6-Cl₃—C₆H₂O |
| 460 | 3,4,5-Cl₃—C₆H₂O |
| 461 | 2-Br—C₆H₄O |
| 462 | 3-Br—C₆H₄O |
| 463 | 4-Br—C₆H₄O |
| 464 | 2,3-Br₂—C₆H₃O |
| 465 | 2,4-Br₂—C₆H₃O |
| 466 | 2,5-Br₂—C₆H₃O |
| 467 | 2,6-Br₂—C₆H₃O |
| 468 | 3,4-Br₂—C₆H₃O |
| 469 | 3,5-Br₂—C₆H₃O |
| 470 | 2-F-3-Cl—C₆H₃O |
| 471 | 2-F-4-Cl—C₆H₃O |
| 472 | 2-F-5-Cl—C₆H₃O |
| 473 | 2-F-3-Br—C₆H₃O |
| 474 | 2-F-4-Br—C₆H₃O |
| 475 | 2-F-5-Br—C₆H₃O |
| 476 | 2-Cl-3-Br—C₆H₃O |
| 477 | 2-Cl-4-Br—C₆H₃O |
| 478 | 2-Cl-5-Br—C₆H₃O |
| 479 | 3-F-4-Cl—C₆H₃O |
| 480 | 3-F-5-Cl—C₆H₃O |
| 481 | 3-F-6-Cl—C₆H₃O |
| 482 | 3-F-4-Br—C₆H₃O |
| 483 | 3-F-5-Br—C₆H₃O |
| 484 | 3-F-6-Br—C₆H₃O |
| 485 | 3-Cl-4-Br—C₆H₃O |
| 486 | 3-Cl-5-Br—C₆H₃O |
| 487 | 3-Cl-6-Br—C₆H₃O |
| 488 | 4-F-5-Cl—C₆H₃O |
| 489 | 4-F-6-Cl—C₆H₃O |
| 490 | 4-F-5-Br—C₆H₃O |
| 491 | 4-F-6-Br—C₆H₃O |
| 492 | 4-Cl-5-Br—C₆H₃O |
| 493 | 5-F-6-Cl—C₆H₃O |
| 494 | 5-F-6-Br—C₆H₃O |
| 495 | 5-Cl-6-Br—C₆H₃O |
| 496 | 3-Br-4-Cl-5-Br—C₆H₂O |
| 497 | 2-CN—C₆H₄O |
| 498 | 3-CN—C₆H₄O |
| 499 | 4-CN—C₆H₄O |
| 500 | 4-[(CH₃)₂N—CO]—C₆H₄O |
| 501 | 2-(CH₃—NH—CO)—C₆H₄O |
| 502 | 3-(CH₃—NH—CO)—C₆H₄O |
| 503 | 4-(CH₃—NH—CO)—C₆H₄O |
| 504 | 2-CH₃S—C₆H₄O |
| 505 | 3-CH₃S—C₆H₄O |
| 506 | 4-CH₃S—C₆H₄O |
| 507 | 2-CH₃SO₂—C₆H₄O |
| 508 | 3-CH₃SO₂—C₆H₄O |
| 509 | 4-CH₃SO₂—C₆H₄O |
| 510 | 2-CF₃O—C₆H₄O |
| 511 | 3-CF₃O—C₆H₄O |
| 512 | 4-CF₃O—C₆H₄O |
| 513 | 2-CHF₂O—C₆H₄O |
| 514 | 4-CHF₂O—C₆H₄O |
| 515 | 4-CHF₂O—C₆H₄O |
| 516 | 3-CF₃-4-CF₃O—C₆H₃O |
| 517 | 2-CH₃NH—C₆H₄O |
| 518 | 3-CH₃NH—C₆H₄O |
| 519 | 4-CH₃NH—C₆H₄O |
| 520 | 2-(CH₃)₂N—C₆H₄O |
| 521 | 3-(CH₃)₂N—C₆H₄O |
| 522 | 4-(CH₃)₂N—C₆H₄O |
| 523 | 2-(C₂H₅—O—CO)—C₆H₄O |
| 524 | 3-(C₂H₅—O—CO)—C₆H₄O |
| 525 | 4-(C₂H₅—O—CO)—C₆H₄O |
| 526 | 2-CH₂FCH₂—C₆H₄O |
| 527 | 3-CH₂FCH₂—C₆H₄O |
| 528 | 4-CH₂FCH₂—C₆H₄O |
| 529 | 2-CF₃CH₂—C₆H₄O |
| 530 | 3-CF₃CH₂—C₆H₄O |
| 531 | 4-CF₃CH₂—C₆H₄O |
| 532 | 2-CHF₂CF₂—C₆H₄O |
| 533 | 3-CHF₂CF₂—C₆H₄O |
| 534 | 4-CHF₂CF₂—C₆H₄O |
| 535 | 2-CHF₂—C₆H₄O |
| 536 | 3-CHF₂—C₆H₄O |
| 537 | 4-CHF₂—C₆H₄O |
| 538 | 2-CH₃O—C₆H₄O |
| 539 | 3-CH₃O—C₆H₄O |
| 540 | 4-CH₃O—C₆H₄O |
| 541 | 2,3-(CH₃O)₂—C₆H₃O |
| 542 | 2,4-(CH₃O)₂—C₆H₃O |
| 543 | 2,5-(CH₃O)₂—C₆H₃O |
| 544 | 3,4-(CH₃O)₂—C₆H₃O |
| 545 | 3,5-(CH₃O)₂—C₆H₃O |
| 546 | 3,4,5-(CH₃O)₃—C₆H₂O |
| 547 | 2-C₂H₅O—C₆H₄O |
| 548 | 3-C₂H₅O—C₆H₄O |
| 549 | 4-C₂H₅O—C₆H₄O |
| 550 | 2-(n-C₃H₇O)—C₆H₄O |
| 551 | 3-(n-C₃H₇O)—C₆H₄O |
| 552 | 4-(n-C₃H₇O)—C₆H₄O |
| 553 | 2-(i-C₃H₇O)—C₆H₄O |
| 554 | 3-(i-C₃H₇O)—C₆H₄O |
| 555 | 4-(i-C₃H₇O)—C₆H₄O |
| 556 | 4-(n-C₄H₉O)—C₆H₄O |
| 557 | 3-(t-C₄H₉O)—C₆H₄O |
| 558 | 4-(t-C₄H₉O)—C₆H₄O |
| 559 | 2-(CH═CH—CH₂—O)—C₆H₄O |
| 560 | 3-(CH═CH—CH₂—O)—C₆H₄O |
| 561 | 4-(CH═CH—CH₂—O)—C₆H₄O |
| 562 | 2-CF₃—C₆H₄O |
| 563 | 3-CF₃—C₆H₄O |
| 564 | 4-CF₃—C₆H₄O |
| 565 | 2-(CH₃—CO)—C₆H₄O |
| 566 | 3-(CH₃—CO)—C₆H₄O |
| 567 | 4-(CH₃—CO)—C₆H₄O |
| 568 | 2-(CH₃—O—CO)—C₆H₄O |
| 569 | 3-(CH₃—O—CO)—C₆H₄O |
| 570 | 4-(CH₃—O—CO)—C₆H₄O |
| 571 | 2-(H₂N—CO)—C₆H₄O |
| 572 | 3-(H₂N—CO)—C₆H₄O |
| 573 | 4-(H₂N—CO)—C₆H₄O |
| 574 | 2-[(CH₃)₂N—CO]—C₆H₄O |
| 575 | 3-[(CH₃)₂N—CO]—C₆H₄O |
| 576 | 2-NO₂—C₆H₄O |
| 577 | 3-NO₂—C₆H₄O |
| 578 | 4-NO₂—C₆H₄O |
| 579 | 2-CH₃—C₆H₄O |
| 580 | 3-CH₃—C₆H₄O |
| 581 | 4-CH₃—C₆H₄O |
| 582 | 2,3-(CH₃)₂—C₆H₃O |
| 583 | 2,4-(CH₃)₂—C₆H₃O |
| 584 | 2,5-(CH₃)₂—C₆H₃O |
| 585 | 2,6-(CH₃)₂—C₆H₃O |
| 586 | 3,4-(CH₃)₂—C₆H₃O |
| 587 | 3,5-(CH₃)₂—C₆H₃O |
| 588 | 2-C₂H₅—C₄H₄O |
| 589 | 3-C₂H₅—C₆H₄O |
| 590 | 4-C₂H₅—C₆H₄O |
| 591 | 2-i-C₃H₇—C₆H₄O |
| 592 | 3-i-C₃H₇—C₆H₄O |
| 593 | 4-i-C₃H₇—C₆H₄O |
| 594 | 3-t-C₄H₉—C₆H₄O |
| 595 | 4-t-C₄H₉—C₆H₄O |
| 596 | 2-H₂C═CH—C₆H₄O |
| 597 | 3-H₂C═CH—C₆H₄O |
| 598 | 4-H₂C═CH—C₆H₄O |
| 599 | 2-(H₂C═CH—CH₂)—C₆H₄O |
| 600 | 3-(H₂C═CH—CH₂)—C₆H₄O |
| 601 | 4-(H₂C═CH—CH₂)—C₆H₄O |
| 602 | 2-C₆H₅—C₆H₄O |
| 603 | 3-C₆H₅—C₆H₄O |
| 604 | 4-C₆H₅—C₆H₄O |
| 605 | 3-CH₃-5-t-C₄H₉—C₆H₃O |
| 606 | 2-F-4-CH₃—C₆H₃O |
| 607 | 2-F-5-CH₃—C₆H₃O |
| 608 | 2-CH₃-4-F—C₆H₃O |
| 609 | 2-CH₃-5-F—C₆H₃O |
| 610 | 2-CH₃-4-Cl—C₆H₃O |
| 611 | 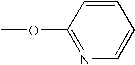 |
| 612 | 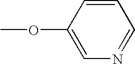 |
| 613 | 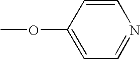 |
| 614 | 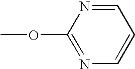 |
| 615 | 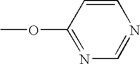 |
| 616 | 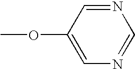 |
| 617 | 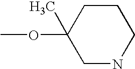 |
| 618 | 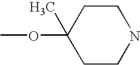 |

Table 63

Compounds of the general formula I.7 in which R₁, R₂ and R₅ are methyl, Q is O and Z corresponds in each case to one line of table B.

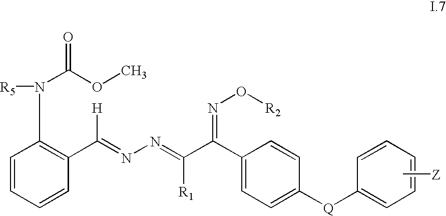

Table 64

Compounds of the general formula I.7 in which R₁, R₂ and R₅ are methyl, Q is OCH₂ and Z corresponds in each case to one line of table B.>

Table 65

Compounds of the general formula I.7 in which R₁, R₂ and R₅ are methyl, Q is CH₂O and Z corresponds in each case to one line of table B.

Table 66

Compounds of the general formula I.7 in which R₁, R₂ and R₅ are methyl, Q is S and Z corresponds in each case to one line of table B.

Table 67

Compounds of the general formula I.7 in which R₁, R₂ and R₅ are methyl, Q is —C≡C— and Z corresponds in each case to one line of table B.

Table 68

Compounds of the general formula I.7 in which R₁, R₂ and R₅ are methyl, Q is —CH═CH— and Z corresponds in each case to one line of table B.

Table 69

Compounds of the general formula I.7 in which R₁, R₂ and R₅ are methyl, Q is —CH₂—CH₂— and Z corresponds in each case to one line of table B.

Table 70

Compounds of the general formula I.7 in which R₁, R₂ and R₅ are methyl, Q is a direct bond and Z corresponds in each case to one line of table B.

Table 71

Compounds of the general formula I.7 in which R₁ and R₅ are methyl, R₂ is ethyl, Q is O and Z corresponds in each case to one line of table B.

Table 72

Compounds of the general formula I.7 in which R₁ and R₅ are methyl, R₂ is ethyl, Q is OCH₂ and Z corresponds in each case to one line of table B.

Table 73

Compounds of the general formula I.7 in which R₁ and R₅ are methyl, R₂ is ethyl, Q is CH₂O and Z corresponds in each case to one line of table B.

Table 74

Compounds of the general formula I.7 in which R₁ and R₅ are methyl, R₂ is ethyl, Q is S and Z corresponds in each case to one line of table B.

Table 75

Compounds of the general formula I.7 in which R₁ and R₅ are methyl, R₂ is ethyl, Q is —C≡C— and Z corresponds in each case to one line of table B.

Table 76

Compounds of the general formula I.7 in which R₁ and R₅ are, methyl, R₂ is ethyl, Q is —CH═CH— and Z corresponds in each case to one line of table B.

Table 77

Compounds of the general formula I.7 in which R₁ and R₅ are methyl, R₂ is ethyl, Q is —CH₂—CH₂— and Z corresponds in each case to one line of table B.

Table 78

Compounds of the general formula I.7 in which R₁ and R₅ are methyl, R₂ is ethyl, Q is a direct bond and Z corresponds in each case to one line of table B.

Table 79

Compounds of the general formula I.7 in which R₁ is ethyl, R₂ and R₅ are methyl, Q is O and Z corresponds in each case to one line of table B.

Table 80

Compounds of the general formula I.7 in which R₁ is ethyl, R₂ and R₅ are methyl, Q is OCH₂ and Z corresponds in each case to one line of table B.

Table 81

Compounds of the general formula I.7 in which R₁ is ethyl, R₂ and R₅ are methyl, Q is CH₂O and Z corresponds in each case to one line of table B.

Table 82

Compounds of the general formula I.7 in which R₁ is ethyl, R₂ and R₅ are methyl, Q is S and Z corresponds in each case to one line of table B.

Table 83

Compounds of the general formula I.7 in which R₁ is ethyl, R₂ and R₅ are methyl, Q is —C≡C— and Z corresponds in each case to one line of table B.

Table 84

Compounds of the general formula I.7 in which R₁ is ethyl, R₂ and R₅ are methyl, Q is —CH═CH— and Z corresponds in each case to one line of table B.

Table 85

Compounds of the general formula I.7 in which R₁ is ethyl, R₂ and R₅ are methyl, Q is —CH₂—CH₂— and Z corresponds in each case to one line of table B.

Table 86

Compounds of the general formula I.7 in which R₁ is ethyl, R₂ and R₅ are methyl, Q is a direct bond and Z corresponds in each case to one line of table B.

Table 87

Compounds of the general formula I.7 in which R₁ and R₂ are ethyl, R₅ is methyl, Q is O and Z corresponds in each case to one line of table B.

Table 88

Compounds of the general formula I.7 in which R₁ and R₂ are ethyl, R₅ is methyl, Q is OCH₂ and Z corresponds in each case to one line of table B.

Table 89

Compounds of the general formula I.7 in which R₁ and R₂ are ethyl, R₅ is methyl, Q is CH₂O and Z corresponds in each case to one line of table B.

Table 90

Compounds of the general formula I.7 in which R₁ and R₂ are ethyl, R₅ is methyl, Q is S and Z corresponds in each case to one line of table B.

Table 91

Compounds of the general formula I.7 in which R₁ and R₂ are ethyl, R₅ is methyl, Q is —C≡C— and Z corresponds in each case to one line of table B.

Table 92

Compounds of the general formula I.7 in which R₁ and R₂ are ethyl, R₅ is methyl, Q is —CH═CH— and Z corresponds in each case to one line of table B.

Table 93

Compounds of the general formula I.7 in which R₁ and R₂ are ethyl, R₅ is methyl, Q is —CH₂—CH₂— and Z corresponds in each case to one line of table B.

Table 94

Compounds of the general formula I.7 in which R₁ and R₂ are-ethyl, R₅ is methyl, Q is a direct bond: and Z corresponds in each case to one line of table B.

Table 95

Compounds of the general formula I.7 in which R₁ and R₅ are methyl, R₂ is propargyl, Q is O and Z corresponds in each case to one line of table B.

Table 96

Compounds of the general formula I.7 in which R₁ is ethyl, R₅ is methyl and R₂ is propargyl, Q is O and Z corresponds in each case to one line of table B.

Table 97

Compounds of the general formula I.7 in which R₁ and R₅ are methyl, R₂ is allyl, Q is O and Z corresponds in each case to one line of table B.

Table 98

Compounds of the general formula I.7 in which R₁ is ethyl, R₅ is methyl, R₂ is allyl, Q is O and Z corresponds in each case to one line of table B.

Table 99

Compounds of the general formula I.7 in which R₁ and R₅ are methyl, R₂ is n-propyl, Q is O and Z corresponds in each case to one line of table B.

Table 100

Compounds of the general formula I.7 in which R₁ is ethyl, R₅ is methyl-, R₂ is n-propyl, Q is O and Z corresponds in each case to one line of table B.

Table 101

Compounds of the general formula I.7 in which R₁ and R₅ are methyl, R₂ is i-propyl, Q is O and Z corresponds in each case to one line of table B.

Table 102

Compounds of the general formula I.7 in which R₁ is ethyl, R₅ is methyl, R₂ is i-propyl, Q is O and Z corresponds in each case to one line of table B.

Table 103

Compounds of the general formula I.7 in which R₁ and R₂ are methyl, R₅ is ethyl, Q is O and Z corresponds in each case to one line of table B.

Table 104

Compounds of the general formula I.7 in which R₁ and R₂ are methyl, R₅ is allyl, Q is O and Z corresponds in each case to one line of table B.

Table 105

Compounds of the general formula I.7 in which R₁ and R₂ are methyl, R₅ is propargyl, Q is O and Z corresponds in each case to one line of table B.

Table 106

Compounds of the general formula I.7 in which R₁ and R₂ are methyl, R₅ is methoxymethyl, Q is O and Z corresponds in each case to one line of table B.

Table 107

Compounds of the general formula I.7 in which R₁ is methyl, R₂ and R₅ are ethyl, Q is O and Z corresponds in each case to one line of table B.

Table 108

Compounds of the general formula I.7 in which R₂ is methyl, R₁ and R₅ are ethyl, Q is O and Z corresponds in each case to one line of table B.

Table 109

Compounds of the general formula I.7 in which R₁, R₂ and R₅ are ethyl, Q is O and Z corresponds in each case to one line of table B.

Table 110

Compounds of the general formula I.7 in which R₁ is methyl, R₂ is ethyl, R₅ is propargyl, Q is O and Z corresponds in each case to one line of table B.

Table 111

Compounds of the general formula I.7 in which R₁ and R₂ are ethyl, R₅ is propargyl, Q is O and Z corresponds in each case to one line of table B.

Table 112

Compounds of the general formula I.7 in which R₁ is methyl, R₂ is ethyl, R₅ is methoxymethyl, Q is O and Z corresponds in each case to one line of table B.

Table 113

Compounds of the general formula I.7 in which R₁ and R₂ is ethyl, R₅ is methoxymethyl, Q is O and Z corresponds in each case to one line of table B.

Table 114

Compounds of the general formula I.8 in which R₁, R₂ and R₅ are methyl, Q is O and Z corresponds in each case to one line of table B.

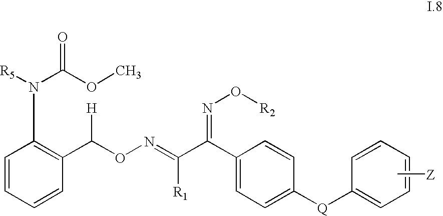

Compounds of the general formula I.8 in which R₁, R₂ and R₅ are methyl, Q is OCH₂ and Z corresponds in each case to one line of table B.

Table 116

Compounds of the general formula I.8 in which R₁, R₂— and R₅ are methyl, Q is CH₂O and Z corresponds in each case to one line of table B.

Table 117

Compounds of the general formula I.8 in which R₁, R₂ and R₅ are methyl, Q is S and Z corresponds in each case to one line of table B.

Table 118

Compounds of the general formula I.8 in which R₁, R₂ and R₅ are methyl, Q is —C≡C— and Z corresponds in each case to one line of table B.

Table 119

Compounds of the general formula I.8 in which R₁, R₂ and R₅ are methyl, Q is —CH═CH— and Z corresponds in each case to one line of table B.

Table 120

Compounds of the general formula I.8 in which R₁, R₂ and R₅ are methyl, Q is —CH₂—CH₂— and Z corresponds in each case to one line of table B.

Table 121

Compounds of the general formula I.8 in which R₁, R₂ and R₅ are methyl, Q is a direct bond and Z corresponds in each case to one line of table B.

Table 122

Compounds of the general formula I.8 in which R₁ and R₅ are methyl, R₂ is ethyl, Q is O and Z corresponds in each case to one line of table B.

Table 123

Compounds of the general formula I.8 in which R₁ and R₅ are methyl, R₂ is ethyl, Q is OCH₂ and Z corresponds in each case to one line of table B.

Table 124

Compounds of the general formula I.8 in which R₁ and R₅ are methyl, R₂ is ethyl, Q is CH₂O and Z corresponds in each case to one line of table B.

Table 125

Compounds of the general formula I.8 in which R₁ and R₅ are methyl, R₂ is ethyl, Q is S and Z corresponds in each case to one line of table B.

Table 126

Compounds of the general formula I.8 in which R₁ and R₅ are methyl, R₂ is ethyl, Q is —C≡C— and Z corresponds in each case to one line of table B.

Table 127

Compounds of the general formula I.8 in which R₁ and R₅ are methyl, R₂ is ethyl, Q is —CH═CH— and Z corresponds in each case to one line of table B.

Table 128

Compounds of the general formula I.8 in which R₁ and R₅ are methyl, R₂ is ethyl, Q is —CH₂—CH₂— and Z corresponds in each case to one line of table B.

Table 129

Compounds of the general formula I.8 in which R₁ and R₅ are methyl, R₂ is ethyl, Q is a direct bond and Z corresponds in each case to one line of table B.

Table 130

Compounds of the general formula I.8 in which R₁ is ethyl, R₂ and R₅ are methyl, Q is O and Z corresponds in each case to one line of table B.

Table 131

Compounds of the general formula I.8 in which R₁ is ethyl, R₂ and R₅ are methyl, Q is OCH₂ and Z corresponds in each case to one line of table B.

Table 132

Compounds of the general formula I.8 in which R₁ is ethyl, R₂ and R₅ are methyl, Q is CH₂O and Z corresponds in each case to one line of table B.

Table 133

Compounds of the general formula I.8 in which R₁ is ethyl, R₂ and R₅ are methyl, Q is S and Z corresponds in each case to one line of table B.

Table 134

Compounds of the general formula I.8 in which R₁ is ethyl, R₂ and R₅ are methyl, Q is —C≡C— and Z corresponds in each case to one line of table B.

Table 135

Compounds of the general formula I.8 in which R₁ is ethyl, R₂ and R₅ are methyl, Q is —CH═CH— and Z corresponds in each case to one line of table B.

Table 136

Compounds of the general formula I.8 in which R₁ is ethyl, R₂ and R₅ are methyl, Q is —CH₂—CH₂— and Z corresponds in each case to one line of table B.

Table 137

Compounds of the general formula I.8 in which R₁ is ethyl, R₂ and R₅ are methyl, Q is a direct bond and Z corresponds in each case to one line of table B.

Table 138

Compounds of the general formula I.8 in which R₁ and R₂ are ethyl, R₅ is methyl, Q is O and Z corresponds in each case to one line of table B.

Table 139

Compounds of the general formula I.8 in which R₁ and R₂ are ethyl, R₅ is methyl, Q is OCH₂ and Z corresponds in each case to one line of table B.

Table 140

Compounds of the general formula I.8 in which R₁ and R₂ are ethyl, R₅ is methyl, Q is CH₂O and Z corresponds in each case to one line of table B.

Table 141

Compounds of the general formula I.8 in which R₁ and R₂ are ethyl, R₅ is methyl, Q is S and Z corresponds in each case to one line of table B.

Table 142

Compounds of the general formula I.8 in which R₁ and R₂ are ethyl, R₅ is methyl, Q is —C≡C— and Z corresponds in each case to one line of table B.

Table 143

Compounds of the general formula I.8 in which R₁ and R₂ are ethyl, R₅ is methyl, Q is —CH═CH— and Z corresponds in each case to one line of table B.

Table 144

Compounds of the general formula I.8 in which R₁ and R₂ are ethyl, R₅ is methyl, Q is —CH₂—CH₂— and Z corresponds in each case to one line of table B.

Table 145

Compounds of the general formula I.8 in which R₁ and R₂ are ethyl, R₅ is methyl, Q is a direct bond and Z corresponds in each case to one line of table B.

Table 146

Compounds of the general formula I.8 in which R₁ and R₅ are methyl, R₂ is propargyl, Q is O and Z corresponds in each case to one line of table B.

Table 147

Compounds of the general formula I.8 in which R₁ is ethyl, R₅ is methyl and R₂ is propargyl, Q is O and Z corresponds in each case to one line of table B.

Table 148

Compounds of the general formula I.8 in which R₁ and R₅ are methyl, R₂ is allyl, Q is O and Z corresponds in each case to one line of table B.

Table 149

Compounds of the general formula I.8 in which R₁ is ethyl, R₅ is methyl, R₂ is allyl, Q is O and Z corresponds in each case to one line of table B.

Table 150

Compounds of the general formula I.8 in which R₁ and R₅ are methyl, R₂ is n-propyl, Q is O and Z corresponds in each case to one line of table B.

Table 151

Compounds of the general formula I.8 in which R₁ is ethyl, R₅ is methyl, R₂ is n-propyl, Q is O and Z corresponds in each case to one line of table B.

Table 152

Compounds of the general formula I.8 in which R₁ and R₅ are methyl, R₂ is i-propyl, Q is O and Z corresponds in each case to one line of table B.

Table 153

Compounds of the general formula I.8 in which R₁ is ethyl, R₅ is methyl, R₂ is i-propyl, Q is O and Z corresponds in each case to one line of table B.

Table 154

Compounds of the general formula I.8 in which R₁ and R₂ are methyl, R₅ is ethyl, Q is O and Z corresponds in each case to one line of table B.

Table 155

Compounds of the general formula I.8 in which R₁ and R₂ are methyl, R₅ is allyl, Q is O and Z corresponds in each case to one line of table B.

Table 156

Compounds of the general formula I.8 in which R₁ and R₂ are methyl, R₅ is propargyl, Q is O and Z corresponds in each case to one line of table B.

Table 157

Compounds of the general formula I.8 in which R₁ and R₂ are methyl, R₅ is methoxymethyl, Q is O and Z corresponds in each case to one line of table B.

Table 158

Compounds of the general formula I.8 in which R₁ is methyl, R₂ and R₅ are ethyl, Q is O and Z corresponds in each case to one line of table B.

Table 159

Compounds of the general formula I.8 in which R₂ is methyl, R₁ and R₅ are ethyl, Q is O and Z corresponds in each case to one line of table B.

Table 160

Compounds of the general formula I.8 in which R₁, R₂ and R₅ are ethyl, Q is O and Z corresponds in each case to one line of table B.

Table 161

Compounds of the general formula I.8 in which R₁ is methyl, R₂ is ethyl, R₅ is propargyl, Q is O and Z corresponds in each case to one line of table B.

Table 162

Compounds of the general formula I.8 in which R₁ and R₂ are ethyl, R₅ is propargyl, Q is O and Z corresponds in each case to one line of table B.

Table 163

Compounds of the general formula I.8 in which R₁ is methyl, R₂ is ethyl, R₅ is methoxymethyl, Q is O and Z corresponds in each case to one line of table B.

Table 164

Compounds of the general formula I.8 in which R₁ and R₂ are ethyl, R₅ is methoxymethyl, Q is O and Z corresponds in each case to one line of table B.

TABLE B

| No. | Z |
|---|---|
| 1 | 2-F |
| 2 | 3-F |
| 3 | 4-F |
| 4 | 2-Cl |
| 5 | 3-Cl |
| 6 | 4-Cl |
| 7 | 2-Br |
| 8 | 3-Br |
| 9 | 4-Br |
| 10 | 2-CH₃ |
| 11 | 3-CH₃ |
| 12 | 4-CH₃ |
| 13 | 2-CH₂CH₃ |
| 14 | 3-CH₂CH₃ |
| 15 | 4-CH₂CH₃ |
| 16 | 4-CH(CH₃)₂ |
| 17 | 4-C(CH₃)₃ |
| 18 | 2-CF₃ |
| 19 | 3-CF₃ |
| 20 | 4-CF₃ |
| 21 | 2-OCF₃ |
| 22 | 3-OCF₃ |
| 23 | 4-OCF₃ |
| 24 | 4-SCF₃ |
| 25 | 4-S(═O)CF₃ |
| 26 | 4-S(═O)₂CF₃ |
| 27 | 4-CN |
| 28 | 2,3-Cl₂ |
| 29 | 2,4-Cl₂ |
| 30 | 2,5-Cl₂ |
| 31 | 2,6-Cl₂ |
| 32 | 3,4-Cl₂ |
| 33 | 3,5-Cl₂ |
| 34 | 3-Cl,4-CF₃ |
| 35 | 4-Cl,3-CF₃ |
| 36 | 3-F,4-CF₃ |
| 37 | 4-F,3-CF₃ |
| 38 | 3,4-(—OCH₂—O—) |
| 39 | 3,4-(—OCF₂—O—) |
| 40 | 3,4-(—OCF₂CF₂—O) |
| 41 | 3,5-(CF₃)₂ |

Formulations may be prepared in analogy to those described in, for example, WO 97/33890.

### BIOLOGICAL EXAMPLES

A. Fungicidal Activities

### Example B-1

### Activity Against Puccinia graminis in Wheat

6 days after sowing, wheat plants are sprayed to runoff with an aqueous spray liquor (0.02% active substance) prepared from a wettable powder of the active substance and 24 hours later are infected with a uredospore suspension of the fungus. After an incubation time of 48 hours (conditions: 95 to 100% relative humidity at, 20° C.), the plants are placed in a greenhouse at 22° C. Fungal infestation is assessed 12 days after infection.

Compounds 1, 2 and 10 to 13 from table A and compounds 1 and 6 to 9 from table B exhibit an activity of more than 80% in this test.

### Example B-2

### Activity Against Phytophthora infestans in Tomatoes

After being grown for three weeks, tomato plants are sprayed to runoff with an aqueous spray liquor (0.02% active substance) prepared from a wettable powder of the active substance and 24 hours later are infected with a sporangia suspension of the fungus. Fungal infestation is assessed 5 days after infection, during which 90 to 100% relative humidity and a temperature of 20° C. are maintained.

Compounds 1 and 10 to 13 from table A exhibit an activity of more than 80% in this test.

### Example B-3

### Residual Protective Activity Against Cercospora arachidicola in Peanuts

Peanut plants 10 to 15 cm high are sprayed to runoff with an aqueous spray liquor (0.02% active substance) prepared from a wettable powder of the active substance and 48 hours later are infected with a conidia suspension of the fungus. The plants are incubated at 21° C. and high atmospheric humidity for 72 hours and then placed in a greenhouse until the typical leaf spots appear. The activity of the active substance is evaluated 12 days after infection, on the basis of the number and size of leaf spots.

Compound 7:from table b exhibits an activity of more than 80% in this test.

### Example B-4

### Activity Against Plasmovara viticola in Vines

Vine seedlings at the 4- to 5-leaf stage are sprayed to runoff with an aqueous spray liquor (0.02% active substance) prepared from a wettable powder of the active substance and 24 hours later are infected with a sporangia suspension of the fungus. Fungal infestation is assessed 6 days after infection, during which from 95 to 100% relative humidity and a temperature of 20° C. are maintained.

Compounds 10 to 13 from table a and compounds 8 and 9 from table b exhibit an activity of more than 80% in this test.

### Example B-5

### Residual Protective Activity Against Venturia inaequalis in Apples

Apple seedlings with fresh shoots 10 to 20 cm long are sprayed to runoff with an aqueous spray liquor (0.02% active substance) prepared from a wettable powder of the active substance and 24 hours later are infected with a conidia suspension of the fungus. The plants are incubated at from 90 to 100 percent relative atmospheric humidity for 5 days and placed in a greenhouse at from 20 to 24° C. for 10 days more. Fungal infestation is assessed 12 days after infection.

Compounds 1 and 10 to 13 from table a and compounds 1 to 4 and 6 to 9 from table b exhibit an activity of more than 80% in this test.

### Example B-6

### Activity Against Erysiphe praminis in Barley

Barley plants approximately 8 cm high are sprayed to runoff with an aqueous spray liquor (0.02% active substance) prepared from a wettable powder of the active substance and 3 to 4 hours later are dusted with conidia of the fungus. The infected plants are placed in a greenhouse at 22° C. Fungal infestation is assessed 12 days after infection.

Compounds 1, 5 and 10 to 13 from table a and compounds 1, 2 and 6 to 9 from table b exhibit an activity of more than 80% in this test.

### Example B-7

### Activity Against Podosphaera leucotricha on Apple Shoots

Apple seedlings with fresh shoots about 15 cm long are sprayed with a spray liquor (0.006% active substance). After 24 hours, the treated plants are infected with a conidia suspension of the fungus and placed in a controlled-climate chamber at 70% relative humidity and 20° C. Fungal infestation is assessed 12 days after infection.

Compounds 10 to 13 from table a and compounds 1, 2 and 9 from table b exhibit an activity of more than 80% in this test.

B. Insecticidal Activities

### Example B-8

### Activity Against Aphis craccivora

Pea seedlings are infected with Aphis craccivora and sprayed with a spray liquor containing 100 ppm active substance and incubated at 20° C. 3 and 6 days later, the percentage reduction in the population (% activity) is determined by comparing the number of dead aphids on the treated and untreated plants.

Compound 5 from table a exhibits good activity in this test, i.e. a kill rate of more than 80%.

### Example B-9

### Activity Against Diabrotica balteata

Maize seedlings are sprayed with an aqueous emulsion spray liquor containing 400 ppm active substance and, after the spray coating is dried on, are populated with 10 second-stage larvae of Diabrotica balteata and placed in a plastic container. 6 days later, the percentage reduction in population (% activity) is determined by comparing the number of dead larvae between the treated and the untreated plants.

Compounds 1 to 5 from table a exhibit good activity in this test, i.e. a kill rate of more than 80%.

### Example B-10

### Activity Against Heliothis virescens

Young soya plants are sprayed with an aqueous emulsion spray liquor containing 1100 ppm active substance and, after the spray coating is dried on, are populated with 10 first-stage caterpillars of Heliothis virescens and placed in a plastic container. 6 days later, the percentage reduction in population and in feeding damage (% activity) is determined by comparing the number of dead caterpillars and the feeding damage between the treated and the untreated plants.

Compounds 1 to 5 from table a exhibit good activity in this test, i.e. a kill rate of more than 80%.

### Example B-11

### Activity Against Spodoptera littoralis

Young soya plants are sprayed with an aqueous emulsion spray liquor containing 100 ppm active substance and, after the spray coating is dried on, are populated with 10 third-stage caterpillars of Spodoptera littoralis and placed in a plastic container. 3 days later, the percentage reduction in population and in, feeding damage (% activity) is determined by comparing the number of dead caterpillars and the feeding damage between the treated and the untreated plants.

Compounds 1 to 5 from table a exhibit good activity in this test, i.e. a kill rate of more than 80%.

### Example B-12

### Activity Against Plutella xylostella Caterpillars

Young cabbage plants are sprayed with an aqueous emulsion spray liquor containing 100 ppm active substance and, after the spray coating is dried on, are populated with 10 third-stage caterpillars of Plutella xylostella and placed in a plastic container. 3 days later, the percentage reduction in population and in feeding damage (% activity) is determined by comparing the number of dead caterpillars and the feeding damage on the treated plants with those on the untreated plants.

Compounds 1 to 5 from table a exhibit good activity in this test, i.e. a kill rate of more than 80%.

### Example B-13

### Activity Against Musca domestica

A sugar cube is treated with a solution of the test substance such that the concentration of test substance after overnight drying is 250 ppm in sugar. This treated cube is placed together with a wet cottonwool pad and 10 adults of an OP-resistant strain of Musca domestica on an aluminium tray, covered with a glass beaker and incubated at 25° C. The mortality rate is determined after 24 hours.

C. Acaricidal Activities

### Example B-14

### Activity Against Tetranychus urticae

Young bean plants are populated with a mixed population of Tetranychus urticae and sprayed one day later with an aqueous emulsion spray liquor containing 400 ppm active substance. The plants are subsequently incubated at: 25° C. for 6 days and then evaluated. The percentage reduction in population (% activity) is determined by comparing the number of dead eggs, larvae and adults on the treated plants with those on the untreated plants.

Compounds 1 to 5 from table a exhibit good activity in this test, i.e. a kill rate of more than 80%.

### Example B-15

### Activity on a Mixed Population of Tetranychus cinnabarinus

Dilution Series.

Dwarf beans at the 2-leaf stage are populated with a mixed population (eggs, larvae/nymphs, adults) of an OP-tolerant Tetranychus cinnabarinus strain. 24 hours after infection, the products are applied to the plants at rates of 200, 100, and 50 mg AS/l in the automatic spray cabin. The substances are formulated and are diluted with water to the appropriate rates. The experiment is evaluated 2 and 7 days after application for percentage mortality against eggs, larvae/nymphs and adults.

### Example B-16

### Activity Against Boophilus microplus

Satiated female adult ticks are adhered to a PVC plate and covered with a cottonwool pad, and the pad is wetted with 10 ml of aqueous test solution containing 125 ppm active substance. The cottonwool pad is removed and the ticks are incubated for 4 weeks until oviposition. The activity is manifested either as mortality or sterility in the females or as ovicidal activity in the case of the eggs.

1. Compounds of the formula I 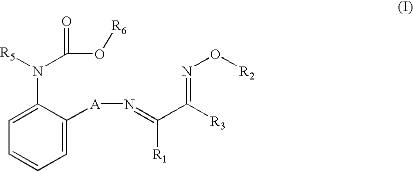
in which
A is —CH₂O— or —CH═N—;
R₁ is C₁-C₄-alkyl or cyclopropyl;
R₂ is C₁-C₆-alkyl, C₂-C₆-alkenyl, or C₂-C₆-alkynyl or is C₁-C₆-alkyl substituted by from 1 to 5 fluorine atoms;
R₃ is C₁-C₆-alkyl, C₁-C₆-alkoxy, C₃-C₆-cycloalkyl, C₃-C₆-cycloalkoxy, C₂-C₆-alkenyl, C₂-C₆-alkenyloxy, C₂-C₆-alkynyl, C₂-C₆-alkynyloxy, C₁-C₆-alkoxycarbonyl or CN, it being possible for the above-mentioned groups except for CN to be substituted by one or more identical or different substituents selected from the group consisting of halogen, cyano, nitro, C₁-C₆-alkoxycarbonyl, C₁-C₆-alkoxy, C₁-C₆-alkylthio, aminocarbonyl, C₁-C₆-alkylaminocarbonyl, di-C₁-C₆-alkylaminocarbonyl, C₂-C₆-alkenyloxy, C₃-C₆-cycloalkyl, C₃-C₆-cycloalkyloxy, heterocyclyl, heterocyclyloxy, aryl, aryloxy, heteroaryl and heteroaryloxy, it being possible for the cyclic radicals to be substituted in turn by one or more identical or different substituents selected from the group consisting of halogen, cyano, nitro, C₁-C₆-alkyl, C₁-C₆-haloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino, C₂-C₆-alkenyl, optionally substituted benzyl, optionally substituted benzyloxy, optionally substituted aryl, optionally substituted aryloxy, optionally substituted heteroaryl and optionally substituted heteroaryloxy; or
R₃ is aryl, heteroaryl, heterocyclyl, aryloxy, heteroaryloxy or heterocyclyloxy, it being possible for the abovementioned groups to be substituted by one or more identical or different substituents selected from the group consisting of halogen, C₁-C₆-alkyl, C₁-C₆-alkoxy, halo-C₁-C₆-alkoxy, halo-C₁-C₆-alkyl, C₁-C₆-alkylthio, halo-C₁-C₆-alkylthio, C₁-C₆-alkylsulfinyl, halo-C₁-C₆-alkylsulfinyl, C₁-C₆-alkylsulfonyl, halo-C₁-C₆-alkylsulfonyl, C₂-C₆-alkenyl, C₂-C₆-alkenyloxy, C₂-C₆-alkynyl, C₃-C₆-alkynyloxy, C₁-C₆-alkylcarbonyl, halo-C₁-C₆-alkylcarbonyl, C₁-C₆-alkoxycarbonyl, halo-C₁-C₆-alkoxycarbonyl, C₁-C₆-alkylaminocarbonyl, di-(C₁-C₆-alkyl)-aminocarbonyl, the alkyl groups being identical or different, C₁-C₆-alkylaminothiocarbonyl, di-(C₁-C₆-alkyl)-aminothiocarbonyl, the alkyl groups being identical or different, C₁-C₆-alkylamino, di-(C₁-C₆-alkyl)-amino, NO₂, a C₁-C₄-alkylenedioxy group which is unsubstituted or substituted from one to four times by C₁-C₄-alkyl and/or halogen; CN, SF₅, OH and QR₄;
Q is a direct bond, oxygen, —O(C₁-C₆-alkylene)-, —(C₁-C₆-alkylene)O—, S(═O)p, —S(═O)p(C₁-C₆-alkylene)-, (C₁-C₆-alkylene)S(═O)p, C₁-C₈-alkylene, C₂-C₆-alkenylene or C₂-C₆-alkynylene;
R₄ is a C₂-C₆-alkenyl or C₂-C₆-alkynyl group which is unsubstituted or substituted by from 1 to 3 halogen atoms; a (C₁-C₄-alkyl)₃Si group, the alkyl groups being identical or different, CN, an unsubstituted or mono- to pentasubstituted C₃-C₆-cycloalkyl, aryl, heteroaryl or heterocyclyl group, the substituents being selected from the group consisting of halogen, C₁-C₆-alkyl, halo-C₁-C₆-alkyl, C₁-C₆-alkoxy, halo-C₁-C₆-alkoxy, phenoxy, CN, SF₅, NO₂, C₁-C₆-alkylsulfinyl, halo-C₁-C₆-alkylsulfinyl, C₁-C₆-alkylsulfonyl, halo-C₁-C₆-alkylsulfonyl and a C₁-C₄-alkylenedioxy which is unsubstituted or substituted from one to four times by C₁-C₄-alkyl and/or halogen;
p is 0, 1 or 2;
R₅ is hydrogen, C₁-C₄-alkyl, C₁-C₂-alkoxymethyl, C₁-C₂-alkylthiomethyl, C₁-C₃-haloalkylmethyl, C₂-C₄-alkenyl, C₂-C₄-alkynyl, C₁-C₃-alkylcarbonyl or C₁-C₂-alkoxycarbonyl, and
R₆ is C₁-C₄-alkyl.

2. Compounds of the formula I according to claim 1, characterized in that
R₁ is methyl or ethyl, preferably methyl;
R₂ is methyl, ethyl, fluoromethyl or trifluoroethyl, preferably methyl;
R₃ is C₁-C₆-alkyl, C₁-C₆-alkoxy, C₂-C₆-alkenyl, C₂-C₆-alkenyloxy, C₂-C₆-alkynyl, C₃-C₆-alkynyloxy, C₃-C₆-cycloalkyl, C₃-C₆-cycloalkyloxy or C₁-C₆-alkoxycarbonyl, it being possible for the abovementioned groups to be partly or fully halogenated; and also CN, OCN or halogen; or
R₃ is phenyl which is unsubstituted or substituted from 1 to 3 times by identical or different substituents selected from halogen, C₁-C₆-alkyl, C₁-C₆-haloalkyl, C₁-C₆-alkoxy, C₁-C₆-haloalkoxy, C₂-C₆-alkenyl, C₂-C₆-alkenyloxy, C₂-C₆-alkynyl, C₃-C₆-alkynyloxy, C₁-C₆-alkoxycarbonyl, CN, OCN, optionally substituted benzyl, optionally substituted phenyl, or optionally substituted phenoxy, it being possible for the above-mentioned aromatic groups to be substituted by one or more identical or different substituents selected from the group consisting of halogen, cyano, nitro, C₁-C₆-alkyl, C₁-C₆-haloalkyl, C₁-C₆-alkoxy, C₁-C₆-haloalkoxy, C₁-C₆-alkoxycarbonyl, C₁-C₆-alkylthio, C₁-C₆-alkylamino, di-C₁-C₆-alkylamino and C₂-C₆-alkenyl; or
R₃ is pyridyl, pyrimidinyl, furyl, thienyl, oxazolyl, isoxazolyl, thiazolyl, isothiazolyl, imidazolyl, pyrazolyl, which are unsubstituted or substituted from 1 to 3 times by identical or different substituents selected from halogen, cyano, nitro, aminocarbonyl, C₁-C₄-alkyl, C₁-C₄-haloalkyl, C₁-C₄-alkylcarbonyl, C₁-C₄-alkylsulfonyl, C₁-C₆-alkylsulfoxyl, C₃-C₆-cycloalkyl, optionally substituted arylcarbonyl, C₁-C₄-alkoxy, C₁-C₄-haloalkoxy, C₁-C₆-alkoxycarbonyl, C₁-C₆-alkylthio, C₁-C₆-alkylamino, di-C₁-C₆-alkylamino, C₁-C₆-alkylaminocarbonyl, di-C₁-C₆-alkylaminocarbonyl or C₂-C₆-alkenyl;
R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and
A is —CH₂O— or —CH═N—.

3. Compounds of the formula I according to claim 2, characterized in that
R₂ is C₁-C₆-alkyl, fluoromethyl, difluoromethyl or 2,2,2-trifluoroethyl;
R₃ is C₁-C₆-alkyl, C₁-C₆-alkoxy, C₁-C₆-alkoxycarbonyl, CN, C₃-C₆-cycloalkyl, phenyl which is unsubstituted or substituted from 1 to 3 times by halogen, C₁-C₄-alkyl, C₁-C₄-haloalkyl, C₁-C₄-alkoxy, C₁-C₄-haloalkoxy, C₂-C₄-alkenyl, C₂-C₄-alkenyloxy, C₂-C₆-alkynyl, C₃-C₆-alkynyloxy, CN, OCN, benzyl, phenyl, or phenoxy, in which the aromatic groups are unsubstituted or substituted 1 or 2 times by halogen, C₁-C₂-alkyl, C₁-C₂-haloalkyl or C₁-C₂-alkoxy; and
A is —CH₂O—.

4. Compounds of the formula I according to claim 3, characterized in that
R₃ is C₁-C₄-alkyl, C₁-C₄-alkoxy, or C₁-C₆-alkoxycarbonyl, or is phenyl which is unsubstituted or substituted 1 or 2 times by halogen, C₁-C₂-alkyl, C₁-C₂-haloalkyl or C₁-C₂-alkoxy.

5. Compounds of the formula I according to claim 1, characterized in that
R₁ is methyl, ethyl or cyclopropyl, preferably methyl;
R₂ is C₁-C₆-alkyl, preferably methyl or ethyl;
R₃ is C₁-C₆-alkyl, C₁-C₆-haloalkyl, C₂-C₆-alkenyl, C₁-C₆-alkoxy, C₂-C₆-alkenyloxy, C₁-C₆-alkoxycarbonyl, CN, C₃-C₆-cycloalkyl; aryl, heteroaryl, heterocyclyl, aryloxy, heteroaryloxy or heterocyclyloxy, it being possible for the hydrocarbon radicals and the cyclic radicals to be substituted as mentioned previously;
R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and
A is —CH₂O— or —CH═N—.

6. Compounds of the formula I according to claim 5, characterized in that
R₃ is C₁-C₆-alkyl, C₁-C₆-haloalkyl, C₂-C₆-alkenyl, C₁-C₆-alkoxy, C₂-C₆-alkenyloxy, C₁-C₆-alkoxycarbonyl or C₃-C₆-cycloalkyl; and
A is —CH₂O—.

7. Compounds of the formula I according to claim 6, characterized in that
R₃ is phenyl which is unsubstituted or substituted 1 or 2 times by halogen, C₁-C₄-alkyl, C₁-C₄-haloalkyl, C₁-C₄-alkoxy, C₁-C₄-haloalkoxy, C₂-C₄-alkenyl, C₂-C₄-alkenyloxy, benzyl, phenyl or phenoxy, in which these aromatic groups are unsubstituted or substituted 1 or 2 times by halogen, C₁-C₂-alkyl, C₁-C₂-haloalkyl or C₁-C₂-alkoxy; and
A is —CH₂O— or —CH═N—.

8. Compounds of the formula I according to claim 1, characterized in that
R₁ is methyl, ethyl or cyclopropyl;
R₂ is C₁-C₆-alkyl, preferably methyl or ethyl, C₂-C₆-alkenyl, preferably allyl or C₂-C₆-alkynyl, preferably propargyl;
R₃ is phenyl substituted by QR₄;
R₅ is hydrogen, methyl, ethyl, methoxymethyl, allyl, propargyl, 2,2,2-trifluoroethyl, methylcarbonyl, ethylcarbonyl or methoxycarbonyl, preferably methyl, ethyl, methoxymethyl, allyl or propargyl; and
A is —CH₂O— or —CH═N—.

9. Compounds according to claim 1 selected from the following group:
methyl N-methyl-[2-({2-ethoxyimino-1-methyl-2-[4-(4-trifluoromethylphenoxy) phenyl]ethylidene}hydrazonomethyl)phenyl]-carbamate,
methyl N-ethyl-[2-({2-ethoxyimino-1-methyl-2-[4-(4-trifluoromethylphenoxy)-phenyl]ethylidene}hydrazonomethyl)phenyl]carbamate,
methyl N-ethyl-[2-({2-ethoxyimino-1-ethyl-2-[4-(4-trifluoromethylphenoxy)-phenyl]ethylidene}hydrazonomethyl)phenyl]carbamate,
methyl N-methyl-[2-({2-ethoxyimino-1-ethyl-2-[4-(4-trifluoromethylphenoxy)-phenyl]ethylidene}hydrazonomethyl)phenyl]carbamate,
methyl N-methoxymethyl-[2-({2-ethoxyimino-1-methyl-2-[4-(4-trifluoromethyl-phenoxy)phenyl]ethylidene}hydrazonomethyl)phenyl]-carbamate,
methyl N-propargyl-[2-({2-methoxyimino-1-methyl-2-[4-(4-trifluoromethyl-phenoxy)phenyl]ethylidene}hydrazonomethyl)phenyl]-carbamate,
methyl N-propargyl-[2-({2-ethoxyimino-1-methyl-2-[4-(4-trnfluoromethylphenoxy)-phenyl]ethylidene}hydrazonomethyl)phenyl]carbamate,
methyl N-propargyl-[2-({2-ethoxyimino-1-ethyl-2-[4-(4-trifluoromethylphenoxy)-phenyl]ethylidene}hydrazonomethyl)phenyl]carbamate,
methyl N-propargyl-[2-({2-ethoxyimino-1-ethyl-2-[4-(4-trifluoromethylphenoxy)-phenyl]ethylidene}hydrazonomethyl)phenyl]carbamate,
methyl N-methyl-[2-({2-methoxyimino-1-methyl-2-(4-chlorophenyl)ethylidene}hydrazonomethyl)phenyl]carbamate,
methyl N-methyl-[2-({2-methoxyimino-1-methyl-2-(4-fluorophenyl)ethylidene}hydrazonomethyl)phenyl]carbamate,
methyl N-methoxyethyl-[2-({2-methoxyimino-1-methyl-2-(4-chlorophenyl)ethylidene}hydrazonomethyl)phenyl]carbamate,
methyl N-methoxyethyl-[2-({2-methoxyimino-1-methyl-2-(4-fluorophenyl)ethylidene}hydrazonomethyl)phenyl]carbamate,
methyl N-methyl-[2-({2-methoxyimino-1-methyl-2-[4-(3-trifluoromethylphenoxy)-phenyl]ethylidene}hydrazonomethyl)phenyl]carbamate,
methyl N-methyl-[2-({2-ethoxyimino-1-ethyl-2-[4-(3-trnfluoromethylphenoxy)-phenyl]ethylidene}hydrazonomethyl)phenyl]carbamate,
methyl N-methyl-[2-({2-ethoxyimino-1-ethyl-2-[4-(3-trifluoromethylphenoxy)-phenyl]ethylidene}hydrazonomethyl)phenyl]carbamate,
methyl N-methyl-[2-({2-methoxyimino-1-methyl-2-[4-(4-chloromethylphenoxy)-phenyl]ethylidene}hydrazonomethyl)phenyl]carbamate,
methyl N-methyl-[2-({2-ethoxyimino-1-methyl-2-[4-(4-chloromethylphenoxy)-phenyl]ethylidene}hydrazonomethyl)phenyl]carbamate,
methyl N-methyl-{2-[2-(4-fluorophenyl)-2-methoxyimino-1-methylethylideneaminooxymethyl]phenyl}carbamate,
methyl N-ethyl-{2-[2-methyl-2-methoxyimino-1-methylethylideneaminooxymethyl]phenyl}carbamate,
methyl N-ethyl-{2-[2-(4-fluorophenyl)-2-methoxyimino-1-methylethylideneaminooxymethyl]phenyl}carbamate,
methyl N-methoxymethyl-{2-[2-methyl-2-methoxyimino-1-methylethylideneaminooxymethyl]phenyl}carbamate, and
methyl N-methyl-{2-[2-(4-(4-trifluoromethylphenoxy)phenyl)-2-ethoxyimino-1-methylethylideneaminooxymethyl]phenyl}carbamate.

10. Process for preparing the compounds of the formula I according to claim 1, characterized in that
A) a compound of the formula I in which A is —CH═N— is-prepared by reacting a hydrazone of the general formula II 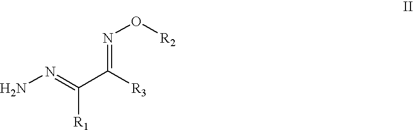
in which R₁, R₂ and R₃ have the meanings indicated under formula I with an aldehyde of the general formula III or one of its acetal or imino derivatives of the general formulae IVa and IVb 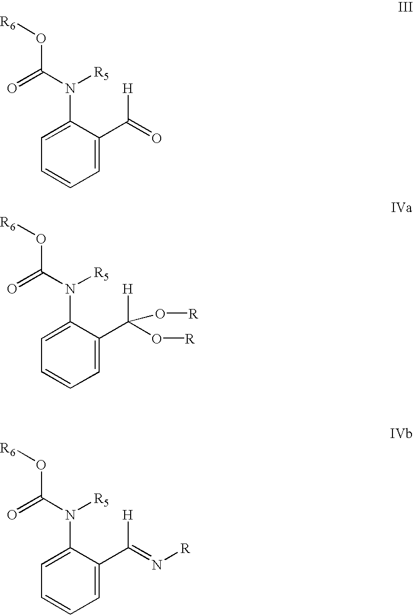
in which R is C₁-C₆-alkyl or the two Rs together with the two oxygen atoms and the carbon to which they are attached are a cyclic acetal, or
B) a compound of the formula I in which A is CH₂O is prepared by reacting an oxime of the general formula V 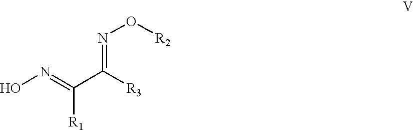
in which R₁, R₂ and R₃ have the meanings indicated under formula I: with a benzyl derivative of the general formula VI, 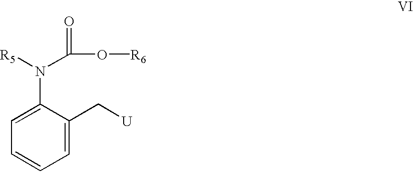
in which R₅ and R₆ have the meanings indicated under formula I and U is a leaving group, or
C) a compound of the formula I in which R₅ is C₁-C₄-alkyl, C₁-C₂-alkoxymethyl, C₁-C₂-alkylthiomethyl, C₁-C₃-haloalkylmethyl, C₂-C₄-alkenyl, C₂-C₄-alkynyl, C₁-C₃-alkylcarbonyl or C₁-C₂-alkoxycarbonyl is prepared by reacting a compound of the formula Ia 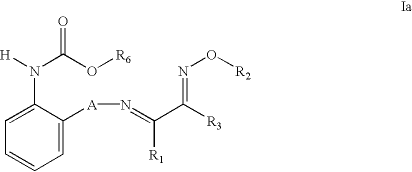
in which A, R₁, R₂, R₃ and R₆ have the meanings indicated under formula I with a compound of the general formula VII,
R₅ₐ-Hal VII
in which R₅ₐ with the exception of hydrogen has the meanings indicated for R₅ and Hal stands for chlorine, bromine or iodine, or
D) a compound of the formula I is prepared by reacting an aniline derivative of the general formula VIII 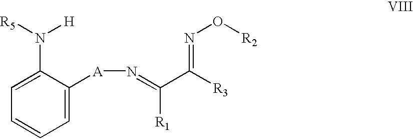
in which R₁, R₂, R₃ and R₅ have the meanings indicated under formula I with a chloroformate of the general formula IX
Cl—COOR₆ IX,
or
E) a compound of the formula I is prepared by etherifying an oxime of the general formula XV 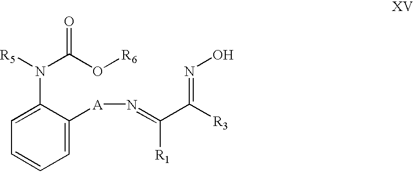
in which R₁, R₃, R₅ and R₆ have the meanings indicated under formula I, or
F) a compound of the formula I is prepared by reacting a ketone of the general formula XVI 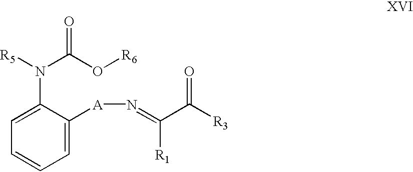
in which R₁, R₃, R₅ and R₆ have the meanings indicated under formula I with an alkoxyamine of the general formula XIX
R₂—ONH₂ XIX
in which R₂ has the meanings indicated under formula I or with one of its salts.

11. Compositions comprising as active substance an effective amount of a compound of the formula I according to claim 1 together with a carrier material suitable for agriculture.

12. Method of controlling acarids and insects and for preventing the infestation of crop plants by phytopathogenic fungi, characterized in that a compound of the formula I according to claim 1 is applied to acarids, insects, crop plants or their habitat.

13. Use of the compounds of the formula I according to claim 1 for controlling acarids and insects and for preventing the infestation of crop plants by phytopathogenic fungi.
